(19) United States
(12) Patent Application Publication
(10) Pub. No.: US 2025/0094737 A1
(43) Pub. Date: Mar. 20, 2025

(54) MANAGING DATE-TIME INTERVALS IN TRANSFORMING NATURAL LANGUAGE TO A LOGICAL FORM

(71) Applicant: Oracle International Corporation, Redwood Shores, CA (US)

(72) Inventors: Gioacchino Tangari, Sydney (AU); Cong Duy Vu Hoang, Melbourne (AU); Dalu Guo, Sydney (AU); Steve Wai-Chun Siu, Melbourne (AU); Stephen Andrew McRitchie, Palo Alto, CA (US); Christopher Mark Broadbent, Wellington, FL (US); Thanh Long Duong, Melbourne (AU); Srinivasa Phani Kumar Gadde, Fremont, CA (US); Vishal Vishnoi, Redwood City, CA (US); Chandan Basavaraju, Bangalore (IN); Kenneth Khiaw Hong Eng, Newark, CA (US)

(73) Assignee: Oracle International Corporation, Redwood Shores, CA (US)

(21) Appl. No.: 18/794,986

(22) Filed: Aug. 5, 2024

Related U.S. Application Data
(60) Provisional application No. 63/520,860, filed on Aug. 21, 2023.
(60) Provisional application No. 63/582,931, filed on Sep. 15, 2023.

(51) Int. Cl. G06F 40/58; G06F 40/166; G06F 40/253; G06F 40/295

(52) U.S. Cl. CPC G06F 40/58; G06F 40/166; G06F 40/253; G06F 40/295

(57) ABSTRACT

Techniques are disclosed herein for managing date-time intervals in transforming natural language utterances to logical forms by providing an enhanced grammar, a natural language utterance comprising a date-time interval, and database schema information to a machine learning model that has been trained to convert natural language utterances to logical forms; and using the machine learning model to convert the natural language utterance to an output logical form, wherein the output logical form comprises at least one of the date-time interval and an extraction function for extracting date-time information corresponding to the date-time interval from at least one date-time attribute of the database schema information.

### CROSS-REFERENCE TO RELATED APPLICATIONS

The present application is a non-provisional application and claims the benefit of and priority to U.S. Provisional Application No. 63/582,931 having a filing date of Sep. 15, 2023, and to U.S. Provisional Application No. 63/520,860 having a filing date of Aug. 21, 2023, the entire contents of which are incorporated herein by reference for all purposes.

### FIELD

The present disclosure relates generally to transforming natural language to a logical form, and more particularly, to techniques for managing date-time intervals in transforming natural language to a logical form.

### BACKGROUND

Artificial intelligence has many applications. To illustrate, many users around the world are on instant messaging or chat platforms in order to get instant reaction. Organizations often use these instant messaging or chat platforms to engage with customers (or end users) in live conversations. However, it can be very costly for organizations to employ service people to engage in live communication with customers or end users. Chatbots or bots have begun to be developed to simulate conversations with end users, especially over the Internet. End users can communicate with bots through messaging apps that the end users have already installed and used. An intelligent bot, generally powered by artificial intelligence (AI), can communicate more intelligently and contextually in live conversations, and thus may allow for a more natural conversation between the bot and the end users for improved conversational experience. Instead of the end user learning a fixed set of keywords or commands that the bot knows how to respond to, an intelligent bot may be able to understand the end user's intention based upon user utterances in natural language and respond accordingly.

Artificial intelligence-based solutions, such as chatbots, may have both analog (human) and digital (machine) interfaces for interacting with a human and connecting to a backend system. It is advantageous to be able to extract and analyze the meaning of an utterance (e.g., a request) when a human makes one using natural language, independent of how a backend system will handle the utterance. As an example, a request might be for data that needs to be retrieved from a relational database, or the requested data might need to be extracted from a knowledge graph. A meaning representation language (MRL) is a versatile representation of a natural language utterance that a chatbot can translate into any number of target machine-oriented languages. As such, an MRL can be utilized by a chatbot to communicate interchangeably with both a human and various backend systems, including systems that communicate using Structured Query Language (SQL), Application Programming Interfaces (APIs), REpresentational State Transfer (REST), Graph Query Language (GraphQL), Property Graph Query Language (PGQL), etc.

For example, SQL is a standard database management language for interacting with relational databases. SQL can be used for storing, manipulating, retrieving, and/or otherwise managing data held in a relational database management system (RDBMS) and/or for stream processing in a relational data stream management system (RDSMS). SQL includes statements or commands that are used to interact with relational databases. SQL statements or commands are classified into, among others, data query language (DQL) statements, data definition language (DDL) statements, data control language (DCL) statements, and data manipulation language (DML) statements. To interact with relational databases using SQL, users must know how the database is structured (e.g., knowledge of the tables and rows and columns within each table), SQL syntax, and how to relate the syntax to the database structure. Without this knowledge, users often have difficultly using SQL to interact with these relational databases.

Natural language interfaces to databases (NLIDB) provide users with a means to interact with these relational databases in an intuitive way without requiring knowledge of a particular database management language. For example, using NLIDB, users can interact with these relational databases using natural language statements and queries (i.e., using plain language). Recently, text-to-SQL systems have become popular and deep learning approaches to converting natural language queries to SQL queries have proved promising. Using semantic parsing, natural language statements, queries, requests, and questions (i.e., sentences) can be transformed into a machine-oriented language that can be executed by an application (e.g., chatbot, model, program, machine, etc.). For example, semantic parsing can transform natural language sentences into general purpose programming languages such as Python, Java, and SQL. Processes for transforming natural language sentences to SQL queries typically include rule-based, statistical-based, and/or deep learning-based systems. Rule-based systems typically use a series of fixed rules to translate the natural language sentences to SQL queries. These rule-based systems are generally domain-specific and, thus, are considered inelastic and do not generalize well to new use cases (e.g., across different domains). Statistical-based systems, such as slot-filling, label tokens (i.e., words or phrases) in an input natural language sentence according to their semantic role in the sentence and use the labels to fill slots in the SQL query. Generally, these statistical-based systems have limitations on the types of sentences that can be parsed (e.g., a sentence must be able to be represented as a parse tree). Deep-learning based systems, such as sequence-to-sequence models, involve training deep-learning models that directly translate the natural language sentences to machine-oriented languages and have been shown to generalize across tasks, domains, and datasets.

### BRIEF SUMMARY

Techniques are disclosed herein for managing date-time intervals in transforming natural language to a logical form.

In various embodiments, a computer-implemented method includes: providing an enhanced grammar, a natural language utterance comprising a date-time interval, and database schema information to a machine learning model that has been trained to convert natural language utterances to logical forms; and using the machine learning model to convert the natural language utterance to an output logical form, wherein the output logical form comprises at least one of the date-time interval and an extraction function for extracting date-time information corresponding to the date-time interval from at least one date-time attribute of the database schema information.

In some embodiments, the output logical form comprises the extraction function, wherein the enhanced grammar comprises a set of relational algebra operators and a set of date-time extraction functions, and wherein the machine learning model converts the natural language utterance to the output logical form based at least in-part on selecting the extracting function from the set of date-time extraction functions.

In some embodiments, the method further includes: prior to using the machine learning model to convert the natural language utterance to the output logical form, accessing a grammar comprising the set of relational algebra operators; and generating the enhanced grammar by adding the set of date-time extraction functions to the grammar.

In some embodiments, the machine learning model has been trained to convert natural language utterances to logical forms by: accessing training data comprising a set of training examples; generating a set of augmented training examples from training examples in the set of training examples by: identifying a subset of training examples in the set of training examples that include date-time intervals; associating the date-time intervals with first extraction functions included in a set of extraction functions that are configured to extract date-time information from date-time attributes included in a database schema; selecting second extraction functions included in the set of extraction functions that are different from the first extraction functions; and modifying logical forms and natural language utterances of training examples in the subset of training examples based on the second extraction functions to result in the set of augmented training examples; and generating augmented training data by combining the set of augmented training examples and the set of training examples; and using the augmented training data to train the machine learning model to convert natural language utterances to logical forms.

In some embodiments, the output logical form comprises the date-time interval, and the method further includes: processing the output logical form to generate a processed output logical form, wherein the processing output logical form to generate the processed output logical form comprises identifying a portion of the output logical form that comprises a logical form operator and the date-time interval and replacing the portion with a replacement extraction function selected from a set of extraction functions that are configured to extract date-information from date-time attributes included in a database schema.

In some embodiments, the processing the output logical form to generate the processed output logical form further comprises using a named entity recognizer to identify a type for the date-time interval and selecting the replacement extraction function based on the type for the date-time interval.

In some embodiments, the method further includes translating the processed output logical form to a query language output statement; providing the query language output statement to a cloud-based platform; using the cloud-based platform to execute the query language output statement on a database associated with the database schema information to retrieve a result describing information corresponding to the date-time interval of the natural language utterance; and providing the result to a user device.

In some embodiments, the method further includes translating the processed output logical form to a query language output statement; providing the query language output statement to a cloud-based platform; using the cloud-based platform to generate a visualization comprising visual information describing information corresponding to the date-time interval of the natural language utterance; and providing the visualization to a user device.

Some embodiments include a system including one or more processors and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a distributed environment incorporating an exemplary embodiment.

FIG. 2 is a simplified block diagram of a computing system implementing a master bot according to certain embodiments.

FIG. 3 is a simplified block diagram of a computing system implementing a skill bot according to certain embodiments.

FIG. 4 is a simplified block diagram illustrating an overview of a NL2LF or C2OMRL architecture and process for generating a query for a backend interface starting with a natural language utterance, in accordance with various embodiments.

FIG. 5 is a simplified block diagram of a C2OMRL architecture in accordance with various embodiments.

FIG. 6A is a simplified block diagram of an example of a system for training, providing, and using machine learning models that can manage date-time intervals in transforming natural language utterances to logical forms in accordance with various embodiments.

FIG. 6B illustrates examples of logical forms that include extraction functions corresponding to date-time intervals in natural language utterances in accordance with various embodiments.

FIG. 6C is a simplified block diagram of an example of a post-processing stage in a system for training, providing, and using machine learning models that can manage date-time intervals in transforming natural language utterances to logical forms in accordance with various embodiments.

FIG. 6D is a diagram of a computing workflow for converting a natural language utterance into a query language output statement that is executed on a database in accordance with various embodiments.

FIG. 6E is a diagram of a computing workflow for converting a natural language utterance into a query language output statement to generate a visualization in accordance with various embodiments.

FIG. 7A is a process flow for using a machine learning model to transform a natural language utterance to a logical form in accordance with various embodiments.

FIG. 7B is a process flow for training and providing a machine learning model for transform a natural language utterance to a logical form in accordance with various embodiments.

FIG. 8 is a block diagram illustrating one pattern for implementing a cloud infrastructure as a service system according to certain embodiments.

FIG. 9 is a block diagram illustrating another pattern for implementing a cloud infrastructure as a service system according to certain embodiments.

FIG. 10 is a block diagram illustrating another pattern for implementing a cloud infrastructure as a service system according to certain embodiments.

FIG. 11 is a block diagram illustrating another pattern for implementing a cloud infrastructure as a service system according to certain embodiments.

FIG. 12 is a block diagram illustrating an example computer system according to certain embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

In recent years, the amount of data powering different industries and their systems has been increasing exponentially. A majority of business information is stored in the form of relational databases that store, process, and retrieve data. Databases power information systems across multiple industries, for instance, consumer tech (e.g., orders, cancellations, refunds), supply chain (e.g., raw materials, stocks, vendors), healthcare (e.g., medical records), finance (e.g., financial business metrics), customer support, search engines, and much more. It is imperative for modern data-driven companies to track the real-time state of its business in order to quickly understand and diagnose any emerging issues, trends, or anomalies in the data and take immediate corrective actions. This work is usually performed manually by analysts who compose complex queries in query languages (e.g., declarative database query languages) like Structured Query Language (SQL) and property graph query language (PGQL). Composing such queries can be used to derive insightful information from data stored in multiple tables. These results are typically processed in the form of charts or graphs to enable users to quickly visualize the results and facilitate data-driven decision making.

Although common database queries (e.g., SQL queries) are often predefined and incorporated in commercial products, any new or follow-up queries still need to be manually coded by the analysts. Such static interactions between database queries and consumption of the corresponding results require time-consuming manual intervention and result in slow feedback cycles. It is vastly more efficient to have non-technical users (e.g., business leaders, doctors, or other users of the data) directly interact with the analytics tables via natural language (NL) queries that abstract away the underlying query language (e.g., SQL) code. Defining the database query requires a strong understanding of database schema and query language syntax and can quickly get overwhelming for beginners and non-technical stakeholders. Efforts to bridge this communication gap have led to the development of a new type of processing called NL interfaces to databases systems (NLIDB), which facilitates search capabilities in databases using NL. Such NL search capabilities have become more popular over recent years, and, as such, companies are developing deep-learning approaches for other NLIDB-type capabilities such as natural language to logical form (NL2LF), NL to SQL (NL2SQL), NL to MRL (NL2MRL), and the like. In the present context, a logical form (LF) of an NL statement or utterance is a precisely specified semantic version of that statement or utterance in a formal system that is machine-understandable and can be used to perform a task such as run queries against databases.

For example, in the case of SQL, an NL utterance (e.g., an end user's question) provided to a NL2SQL system converts the NL utterance to a SQL statement which can then be executed against a database. In the case of MRL such as Oracle's Meaning Representation Language (referred to herein as “OMRL”), an NL utterance provided to a NL2MRL system such as a conversation to OMRL (C2OMRL) system converts the NL utterance to an OMRL statement which can then be translated into one or more desired query languages such as SQL or PGQL and then executed against a database. In this way, these systems facilitate executing unstructured queries (e.g., such as a query encompassed by the NL utterance) against databases.

Integrating these NL2LF systems into cloud-based server systems such as Oracle's Cloud Infrastructure (OCI) and/or Oracle's Analytics Cloud (OAC) has been beneficial in supporting data analytics and visualization use cases (referred to herein as “analytics”, thus enabling users to request data analytics and visualizations for a given dataset using NL. Many analytics use cases involve date-time intervals and, particularly, requests to aggregate or bin the results over a particular date-time interval (e.g., month, year, week, hour) and requests to filter the results for a particular date-time interval. For example, as shown in Table 1 below, an end user's query may involve a request in which the results are aggregated (or binned) over a particular date-time interval such as a month/year/week/hour (e.g., “Show total profit by month . . . ” and “Show average sales . . . ”). In another example, also shown in Table 1 below, an end user's query may involve requesting for the results to be filtered over a particular date-time interval such as an interval starting at the beginning of one month and ending at the end of the next month (e.g., “Show average sales by . . . February”).

TABLE 1

| NL Query | Type |
|---|---|
| Show total profit by month of order date | Aggregating (binning) over |
| Show average sales by order year | date-time intervals |
| Show average sales by product category in | Filtering over date-time |
| February | intervals |

However, when these NL2LF systems encounter end user queries that involve a request to aggregate or bin the results over a date-time interval or filter the results over a date-time interval, information regarding the type of date-time interval may not be reflected and/or may be incorrectly or inaccurately reflected in the converted LF. For example, as shown in Table 2 below, in the case of a request involving aggregating over a date-time interval (e.g., “total profit”), the converted LF (e.g., the OMRQL output by the C20MRL system) does not identify the type of date-time interval in the NL query (e.g., a month “order_date” or a year “order_date”). As a result, as shown in Table 2 below, the same converted LF would be generated for “month of ‘order_date’” and “year of ‘order_date’” date-time intervals of the respective NL queries. In another example, as shown in Table 2, in the case of a request involving filtering the results over a date-time interval (e.g., the “month” type of date-time interval in the NL utterance “product category in February”), the converted LF includes the date-time interval (e.g., “Jan. 2, 2023 AND 28-02-2023”) but does not identify the type of date-time interval in the NL query (e.g., “product category in February”). As a result, in both of these cases, the converted LF may have a negative impact on a downstream task such as generating a visualization that does not show the interval type desired by the end user or does not enable the interactivity desired by the end user, and the like.

TABLE 2

| NL Query | Type | C2OMRL Output (OMRQL) |
|---|---|---|
| Show total profit by | Aggregating (binning) | SELECT SUM(profit), order_date FROM orders |
| month of order date | over date-time | GROUP BY order_date |
| Show average sales | intervals | SELECT AVG(profit), order_date FROM orders |
| by order year | | GROUP BY order_date |
| Show average sales | Filtering over date- | SELECT AVG(profit), product_category FROM |
| by product category | time intervals | orders GROUP BY order_date BETWEEN |
| in February | | 1 Feb. 2023 AND 28 Feb. 2023 |

One option to support date-time intervals in NL2LF systems would be to extend the database schema provided together with the input NL utterance with additional “derived attributes” for each of the date-time attributes in the database schema such that all potential date-time intervals for each date-time attribute are supported. For example, a database schema that includes an “order_date” date-time attribute could be extended to include the following date-time attributes for the “order_date” date-time attribute: “month_order_date,” “week_order_date,” “year_order_date,” “day_order_date,” “day_of_month_order_date,” and/or “day_of_week_order_date” among others. However, this option is not feasible because: it can lead to much larger database schemas, which can result in longer model training times and model prediction latencies; and it can increase the chances of attribute confusion since the input to the NL2LF system may include many similar attributes with partially overlapping names being input together (e.g., to an encoder of a model of the NL2LF system). Accordingly, it may be desirable to provide techniques that allow the NL2LF system (e.g., a C2OMRL system) to manage different date-time intervals without extending the input database schema with extra attributes for each date-time interval type.

The developed approach described herein addresses these challenges and others by providing techniques for managing cases involving binning over date-time intervals and techniques for managing cases involving filtering over date-time intervals. To manage the cases involving aggregating over date-time intervals, the developed approach enriches the grammar of the NL2LF model (e.g., C2OMRL model) to support a plurality of date-time extraction functions in generating the raw model prediction (e.g., a relational algebra tree predicted based on an enhanced relational algebra grammar) and teaches the NL2LF model to predict the date-time extraction functions corresponding to the date-time intervals in the inputs. The grammar of the NL2LF model serves to define the “raw” model output (i.e., the output LF) based on the input utterance. The date-time extraction functions, which represent particular date-time interval types (e.g., the month, year, week, day, etc.), extract the date-time intervals of interest from existing date-time columns in the database schema based on the types of the date-time intervals. Enabling these functions in a NL2LF system such as a C2OMRL system enables the NL2LF system to support different date-time interval types without adding any additional “derived attributes” to the database schema. To teach the NL2LF model to predict the date-time extraction functions, a set of training examples (e.g., tuples of an NL utterance, the OMRQL for the NL utterance, and database schema) are augmented to diversify the date-time intervals in the NL utterances and the grammar is enriched with date-time extraction functions to support the date-time intervals.

To manage the cases involving filtering over date-time intervals, the developed approach processes the raw model predictions that include filter conditions (e.g., WHERE, BETWEEN, OCCUR) followed by date-time attributes (e.g., BETWEEN Jan. 2, 2023 AND 28-02-2023) into final model predictions in which the date-time attributes are transformed into date-time extraction functions corresponding to the date-time attributes, which can serve to identify the date-time intervals in the final model predictions. To perform the processing, information (e.g., entities) exposed by a named entity recognizer is used to inform the transformation processing. Using these techniques, the developed approach enables the NL2LF system to output LFs with the types of the date-time intervals identified, which in turn allows the NL2LF system to support all the date-time interval use cases described above.

In various embodiments, a computer-implemented method includes: providing an enhanced grammar, a natural language utterance comprising a date-time interval, and database schema information to a machine learning model that has been trained to convert natural language utterances to logical forms; and using the machine learning model to convert the natural language utterance to an output logical form, wherein the output logical form comprises at least one of the date-time interval and an extraction function for extracting date-time information corresponding to the date-time interval from at least one date-time attribute of the database schema information.

As used herein, when an action is “based on” something, this means the action is based at least in part on at least a part of the something. As used herein, the terms “similarly,” “substantially,” “approximately” and “about” are defined as being largely but not necessarily wholly what is specified (and include wholly what is specified) as understood by one of ordinary skill in the art. In any disclosed embodiment, the term “similarly,” “substantially,” “approximately,” or “about” may be substituted with “within [a percentage] of” what is specified, where the percentage includes 0.1, 1, 5, and 10 percent.

### Bot Systems

A bot (also referred to as a skill, chatbot, chatterbot, or talkbot) is a computer program that can perform conversations with end users. The bot can generally respond to natural-language messages (e.g., questions or comments) through a messaging application that uses natural-language messages. Enterprises may use one or more bots to communicate with end users through a messaging application. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile and web app extensions that extend native or hybrid/responsive mobile apps or web applications with chat capabilities, or voice based input (such as devices or apps with interfaces that use Siri, Cortana, Google Voice, or other speech input for interaction).

In some examples, the bot may be associated with a Uniform Resource Identifier (URI). The URI may identify the bot using a string of characters. The URI may be used as a webhook for one or more messaging application systems. The URI may include, for example, a Uniform Resource Locator (URL) or a Uniform Resource Name (URN). The bot may be designed to receive a message (e.g., a hypertext transfer protocol (HTTP) post call message) from a messaging application system. The HTTP post call message may be directed to the URI from the messaging application system. In some examples, the message may be different from a HTTP post call message. For example, the bot may receive a message from a Short Message Service (SMS). While discussion herein refers to communications that the bot receives as a message, it should be understood that the message may be an HTTP post call message, a SMS message, or any other type of communication between two systems.

End users interact with the bot through conversational interactions (sometimes referred to as a conversational user interface (UI)), just as end users interact with other people. In some cases, the conversational interactions may include the end user saying “Hello” to the bot and the bot responding with a “Hi” and asking the end user how it can help. End users also interact with the bot through other types of interactions, such as transactional interactions (e.g., with a banking bot that is at least trained to transfer money from one account to another), informational interactions (e.g., with a human resources bot that is at least trained check the remaining vacation hours the user has), and/or retail interactions (e.g., with a retail bot that is at least trained for discussing returning purchased goods or seeking technical support).

In some examples, the bot may intelligently handle end user interactions without intervention by an administrator or developer of the bot. For example, an end user may send one or more messages to the bot in order to achieve a desired goal. A message may include certain content, such as text, emojis, audio, image, video, or other method of conveying a message. In some examples, the bot may automatically convert content into a standardized form and generate a natural language response. The bot may also automatically prompt the end user for additional input parameters or request other additional information. In some examples, the bot may also initiate communication with the end user, rather than passively responding to end user utterances.

A conversation with a bot may follow a specific conversation flow including multiple states. The flow may define what would happen next based on an input. In some examples, a state machine that includes user defined states (e.g., end user intents) and actions to take in the states or from state to state may be used to implement the bot. A conversation may take different paths based on the end user input, which may impact the decision the bot makes for the flow. For example, at each state, based on the end user input or utterances, the bot may determine the end user's intent in order to determine the appropriate next action to take. As used herein and in the context of an utterance, the term “intent” refers to an intent of the user who provided the utterance. For example, the user may intend to engage the bot in a conversation to order pizza, where the user's intent would be represented through the utterance “order pizza.” A user intent can be directed to a particular task that the user wishes the bot to perform on behalf of the user. Therefore, utterances reflecting the user's intent can be phrased as questions, commands, requests, and the like.

In the context of the configuration of the bot, the term “intent” is also used herein to refer to configuration information for mapping a user's utterance to a specific task/action or category of task/action that the bot can perform. In order to distinguish between the intent of an utterance (i.e., a user intent) and the intent of the bot, the latter is sometimes referred to herein as a “bot intent.” A bot intent may comprise a set of one or more utterances associated with the intent. For instance, an intent for ordering pizza can have various permutations of utterances that express a desire to place an order for pizza. These associated utterances can be used to train an intent classifier of the bot to enable the intent classifier to subsequently determine whether an input utterance from a user matches the order pizza intent. Bot intents may be associated with one or more dialog flows for starting a conversation with the user and in a certain state. For example, the first message for the order pizza intent could be the question “What kind of pizza would you like?” In addition to associated utterances, bot intents may further comprise named entities that relate to the intent. For example, the order pizza intent could include variables or parameters used to perform the task of ordering pizza (e.g., topping 1, topping 2, pizza type, pizza size, pizza quantity, and the like). The value of an entity is typically obtained through conversing with the user.

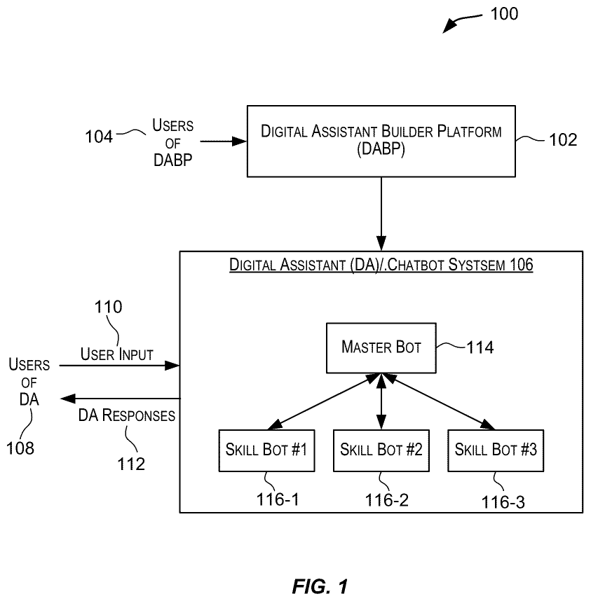

FIG. 1 is a simplified block diagram of an environment 100 incorporating a chatbot system according to certain embodiments. Environment 100 comprises a digital assistant builder platform (DABP) 102 that enables users 104 of DABP 102 to create and deploy digital assistants or chatbot systems. DABP 102 can be used to create one or more digital assistants (or DAs) or chatbot systems. For example, as shown in FIG. 1, users 104 representing a particular enterprise can use DABP 102 to create and deploy a digital assistant 106 for users of the particular enterprise. For example, DABP 102 can be used by a bank to create one or more digital assistants for use by the bank's customers. The same DABP 102 platform can be used by multiple enterprises to create digital assistants. As another example, an owner of a restaurant (e.g., a pizza shop) may use DABP 102 to create and deploy a digital assistant that enables customers of the restaurant to order food (e.g., order pizza).

For purposes of this disclosure, a “digital assistant” is a tool that helps users of the digital assistant accomplish various tasks through natural language conversations. A digital assistant can be implemented using software only (e.g., the digital assistant is a digital tool implemented using programs, code, or instructions executable by one or more processors), using hardware, or using a combination of hardware and software. A digital assistant can be embodied or implemented in various physical systems or devices, such as in a computer, a mobile phone, a watch, an appliance, a vehicle, and the like. A digital assistant is also sometimes referred to as a chatbot system. Accordingly, for purposes of this disclosure, the terms digital assistant and chatbot system are interchangeable.

A digital assistant, such as digital assistant 106 built using DABP 102, can be used to perform various tasks via natural language-based conversations between the digital assistant and its users 108. As part of a conversation, a user may provide one or more user inputs 110 to digital assistant 106 and get responses 112 back from digital assistant 106. A conversation can include one or more of inputs 110 and responses 112. Via these conversations, a user can request one or more tasks to be performed by the digital assistant and, in response, the digital assistant is configured to perform the user-requested tasks and respond with appropriate responses to the user.

User inputs 110 are generally in a natural language form and are referred to as utterances. A user utterance 110 can be in text form, such as when a user types in a sentence, a question, a text fragment, or even a single word and provides it as input to digital assistant 106. In some examples, a user utterance 110 can be in audio input or speech form, such as when a user says or speaks something that is provided as input to digital assistant 106. The utterances are typically in a language spoken by the user. For example, the utterances may be in English, or some other language. When an utterance is in speech form, the speech input is converted to text form utterances in that particular language and the text utterances are then processed by digital assistant 106. Various speech-to-text processing techniques may be used to convert a speech or audio input to a text utterance, which is then processed by digital assistant 106. In some examples, the speech-to-text conversion may be done by digital assistant 106 itself.

An utterance, which may be a text utterance or a speech utterance, can be a fragment, a sentence, multiple sentences, one or more words, one or more questions, combinations of the aforementioned types, and the like. Digital assistant 106 is configured to apply natural language understanding (NLU) techniques to the utterance to understand the meaning of the user input. As part of the NLU processing for an utterance, digital assistant 106 is configured to perform processing to understand the meaning of the utterance, which involves identifying one or more intents and one or more entities corresponding to the utterance. Upon understanding the meaning of an utterance, digital assistant 106 may perform one or more actions or operations responsive to the understood meaning or intents. For purposes of this disclosure, it is assumed that the utterances are text utterances that have been provided directly by a user of digital assistant 106 or are the results of conversion of input speech utterances to text form. This however is not intended to be limiting or restrictive in any manner.

For example, a user input may request a pizza to be ordered by providing an utterance such as “I want to order a pizza.” Upon receiving such an utterance, digital assistant 106 is configured to understand the meaning of the utterance and take appropriate actions. The appropriate actions may involve, for example, responding to the user with questions requesting user input on the type of pizza the user desires to order, the size of the pizza, any toppings for the pizza, and the like. The responses provided by digital assistant 106 may also be in natural language form and typically in the same language as the input utterance. As part of generating these responses, digital assistant 106 may perform natural language generation (NLG). For the user ordering a pizza, via the conversation between the user and digital assistant 106, the digital assistant may guide the user to provide all the requisite information for the pizza order, and then at the end of the conversation cause the pizza to be ordered. Digital assistant 106 may end the conversation by outputting information to the user indicating that the pizza has been ordered.

At a conceptual level, digital assistant 106 performs various processing in response to an utterance received from a user. In some examples, this processing involves a series or pipeline of processing steps including, for example, understanding the meaning of the input utterance, determining an action to be performed in response to the utterance, where appropriate causing the action to be performed, generating a response to be output to the user responsive to the user utterance, outputting the response to the user, and the like. The NLU processing can include parsing the received input utterance to understand the structure and meaning of the utterance, refining, and reforming the utterance to develop a better understandable form (e.g., LF) or structure for the utterance. Generating a response may include using NLG techniques.

The NLU processing performed by a digital assistant, such as digital assistant 106, can include various NLP related tasks such as sentence parsing (e.g., tokenizing, lemmatizing, identifying part-of-speech tags for the sentence, identifying named entities in the sentence, generating dependency trees to represent the sentence structure, splitting a sentence into clauses, analyzing individual clauses, resolving anaphoras, performing chunking, and the like). In certain examples, the NLU processing is performed by digital assistant 106 itself. In some other examples, digital assistant 106 may use other resources to perform portions of the NLU processing. For example, the syntax and structure of an input utterance sentence may be identified by processing the sentence using a parser, a part-of-speech tagger, and/or a NER. In one implementation, for the English language, a parser, a part-of-speech tagger, and a named entity recognizer such as ones provided by the Stanford NLP Group are used for analyzing the sentence structure and syntax. These are provided as part of the Stanford CoreNLP toolkit.

While the various examples provided in this disclosure show utterances in the English language, this is meant only as an example. In certain examples, digital assistant 106 is also capable of handling utterances in languages other than English. Digital assistant 106 may provide subsystems (e.g., components implementing NLU functionality) that are configured for performing processing for different languages. These subsystems may be implemented as pluggable units that can be called using service calls from an NLU core server. This makes the NLU processing flexible and extensible for each language, including allowing different orders of processing. A language pack may be provided for individual languages, where a language pack can register a list of subsystems that can be served from the NLU core server.

A digital assistant, such as digital assistant 106 depicted in FIG. 1, can be made available or accessible to its users 108 through a variety of different channels, such as but not limited to, via certain applications, via social media platforms, via various messaging services and applications, and other applications or channels. A single digital assistant can have several channels configured for it so that it can be run on and be accessed by different services simultaneously.

A digital assistant or chatbot system generally contains or is associated with one or more skills. In certain embodiments, these skills are individual chatbots (referred to as skill bots) that are configured to interact with users and fulfill specific types of tasks, such as tracking inventory, submitting timecards, creating expense reports, ordering food, checking a bank account, making reservations, buying a widget, and the like. For example, for the embodiment depicted in FIG. 1, digital assistant or chatbot system 106 includes skills 116-1, 116-2, 116-3, and so on. For purposes of this disclosure, the terms “skill” and “skills” are used synonymously with the terms “skill bot” and “skill bots,” respectively.

Each skill associated with a digital assistant helps a user of the digital assistant complete a task through a conversation with the user, where the conversation can include a combination of text or audio inputs provided by the user and responses provided by the skill bots. These responses may be in the form of text or audio messages to the user and/or using simple user interface elements (e.g., select lists) that are presented to the user for the user to make selections.

There are various ways in which a skill or skill bot can be associated or added to a digital assistant. In some instances, a skill bot can be developed by an enterprise and then added to a digital assistant using DABP 102. In other instances, a skill bot can be developed and created using DABP 102 and then added to a digital assistant created using DABP 102. In yet other instances, DABP 102 provides an online digital store (referred to as a “skills store”) that offers multiple skills directed to a wide range of tasks. The skills offered through the skills store may also expose various cloud services. In order to add a skill to a digital assistant being generated using DABP 102, a user of DABP 102 can access the skills store via DABP 102, select a desired skill, and indicate that the selected skill is to be added to the digital assistant created using DABP 102. A skill from the skills store can be added to a digital assistant as is or in a modified form (for example, a user of DABP 102 may select and clone a particular skill bot provided by the skills store, make customizations or modifications to the selected skill bot, and then add the modified skill bot to a digital assistant created using DABP 102).

Various different architectures may be used to implement a digital assistant or chatbot system. For example, in certain embodiments, the digital assistants created and deployed using DABP 102 may be implemented using a master bot/child (or sub) bot paradigm or architecture. According to this paradigm, a digital assistant is implemented as a master bot that interacts with one or more child bots that are skill bots. For example, in the embodiment depicted in FIG. 1, digital assistant 106 comprises a master bot 114 and skill bots 116-1, 116-2, etc. that are child bots of master bot 114. In certain examples, digital assistant 106 is itself considered to act as the master bot.

A digital assistant implemented according to the master-child bot architecture enables users of the digital assistant to interact with multiple skills through a unified user interface, namely via the master bot. When a user engages with a digital assistant, the user input is received by the master bot. The master bot then performs processing to determine the meaning of the user input utterance. The master bot then determines whether the task requested by the user in the utterance can be handled by the master bot itself, else the master bot selects an appropriate skill bot for handling the user request and routes the conversation to the selected skill bot. This enables a user to converse with the digital assistant through a common single interface and still provide the capability to use several skill bots configured to perform specific tasks. For example, for a digital assistance developed for an enterprise, the master bot of the digital assistant may interface with skill bots with specific functionalities, such as a customer relationship management (CRM) bot for performing functions related to customer relationship management, an enterprise resource planning (ERP) bot for performing functions related to enterprise resource planning, a human capital management (HCM) bot for performing functions related to human capital management, etc. This way the end user or consumer of the digital assistant need only know how to access the digital assistant through the common master bot interface and behind the scenes multiple skill bots are provided for handling the user request.

In certain examples, in a master bot/child bots' infrastructure, the master bot is configured to be aware of the available list of skill bots. The master bot may have access to metadata that identifies the various available skill bots, and for each skill bot, the capabilities of the skill bot including the tasks that can be performed by the skill bot. Upon receiving a user request in the form of an utterance, the master bot is configured to, from the multiple available skill bots, identify or predict a specific skill bot that can best serve or handle the user request. The master bot then routes the utterance (or a portion of the utterance) to that specific skill bot for further handling. Control thus flows from the master bot to the skill bots. The master bot can support multiple input and output channels. In certain examples, routing may be performed with the aid of processing performed by one or more available skill bots. For example, as discussed below, a skill bot can be trained to infer an intent for an utterance and to determine whether the inferred intent matches an intent with which the skill bot is configured. Thus, the routing performed by the master bot can involve the skill bot communicating to the master bot an indication of whether the skill bot has been configured with an intent suitable for handling the utterance.

While the embodiment in FIG. 1 shows digital assistant 106 comprising a master bot 114 and skill bots 116-1, 116-2, and 116-3, this is not intended to be limiting. A digital assistant can include various other components (e.g., other systems and subsystems) that provide the functionalities of the digital assistant. These systems and subsystems may be implemented only in software (e.g., code, instructions stored on a computer-readable medium and executable by one or more processors), in hardware only, or in implementations that use a combination of software and hardware.

DABP 102 provides an infrastructure and various services and features that enable a user of DABP 102 to create a digital assistant including one or more skill bots associated with the digital assistant. In some instances, a skill bot can be created by cloning an existing skill bot, for example, cloning a skill bot provided by the skills store. As previously indicated, DABP 102 provides a skills store or skills catalog that offers multiple skill bots for performing various tasks. A user of DABP 102 can clone a skill bot from the skills store. As needed, modifications or customizations may be made to the cloned skill bot. In some other instances, a user of DABP 102 created a skill bot from scratch using tools and services offered by DABP 102. As previously indicated, the skills store or skills catalog provided by DABP 102 may offer multiple skill bots for performing various tasks.

In certain examples, at a high level, creating or customizing a skill bot involves the following steps:
(1) Configuring settings for a new skill bot
(2) Configuring one or more intents for the skill bot
(3) Configuring one or more entities for one or more intents
(4) Training the skill bot
(5) Creating a dialog flow for the skill bot
(6) Adding custom components to the skill bot as needed
(7) Testing and deploying the skill bot
   Each of the above steps is briefly described below.

(1) Configuring settings for a new skill bot-Various settings may be configured for the skill bot. For example, a skill bot designer can specify one or more invocation names for the skill bot being created. These invocation names can then be used by users of a digital assistant to explicitly invoke the skill bot. For example, a user can input an invocation name in the user's utterance to explicitly invoke the corresponding skill bot.

(2) Configuring one or more intents and associated example utterances for the skill bot—The skill bot designer specifies one or more intents (also referred to as bot intents) for a skill bot being created. The skill bot is then trained based upon these specified intents. These intents represent categories or classes that the skill bot is trained to infer for input utterances. Upon receiving an utterance, a trained skill bot infers an intent for the utterance, where the inferred intent is selected from the predefined set of intents used to train the skill bot. The skill bot then takes an appropriate action responsive to an utterance based upon the intent inferred for that utterance. In some instances, the intents for a skill bot represent tasks that the skill bot can perform for users of the digital assistant. Each intent is given an intent identifier or intent name. For example, for a skill bot trained for a bank, the intents specified for the skill bot may include “CheckBalance,” “TransferMoney,” “DepositCheck,” and the like.

For each intent defined for a skill bot, the skill bot designer may also provide one or more example utterances that are representative of and illustrate the intent. These example utterances are meant to represent utterances that a user may input to the skill bot for that intent. For example, for the CheckBalance intent, example utterances may include “What's my savings account balance?,” “How much is in my checking account?”, “How much money do I have in my account,” and the like. Accordingly, various permutations of typical user utterances may be specified as example utterances for an intent.

The intents and their associated example utterances are used as training data to train the skill bot. Various different training techniques may be used. As a result of this training, a predictive model is generated that is configured to take an utterance as input and output an intent inferred for the utterance by the predictive model. In some instances, input utterances are provided to an intent analysis engine, which is configured to use the trained model to predict or infer an intent for the input utterance. The skill bot may then take one or more actions based upon the inferred intent.

(3) Configuring entities for one or more intents of the skill bot—In some instances, additional context may be needed to enable the skill bot to properly respond to a user utterance. For example, there may be situations where a user input utterance resolves to the same intent in a skill bot. For instance, in the above example, utterances “What's my savings account balance?” and “How much is in my checking account?” both resolve to the same CheckBalance intent, but these utterances are different requests asking for different things. To clarify such requests, one or more entities are added to an intent. Using the banking skill bot example, an entity called AccountType, which defines values called “checking” and “saving” may enable the skill bot to parse the user request and respond appropriately. In the above example, while the utterances resolve to the same intent, the value associated with the AccountType entity is different for the two utterances. This enables the skill bot to perform possibly different actions for the two utterances in spite of them resolving to the same intent. One or more entities can be specified for certain intents configured for the skill bot. Entities are thus used to add context to the intent itself. Entities help describe an intent more fully and enable the skill bot to complete a user request.

In certain examples, there are two types of entities: (a) built-in entities provided by DABP 102, and (2) custom entities that can be specified by a skill bot designer. Built-in entities are generic entities that can be used with a wide variety of bots. Examples of built-in entities include, without limitation, entities related to time, date, addresses, numbers, email addresses, duration, recurring time periods, currencies, phone numbers, URLs, and the like. Custom entities are used for more customized applications. For example, for a banking skill, an AccountType entity may be defined by the skill bot designer that enables various banking transactions by checking the user input for keywords like checking, savings, and credit cards, etc.

(4) Training the skill bot-A skill bot is configured to receive user input in the form of utterances parse or otherwise process the received input and identify or select an intent that is relevant to the received user input. As indicated above, the skill bot has to be trained for this. In certain embodiments, a skill bot is trained based upon the intents configured for the skill bot and the example utterances associated with the intents (collectively, the training data), so that the skill bot can resolve user input utterances to one of its configured intents. In certain examples, the skill bot uses a predictive model that is trained using the training data and allows the skill bot to discern what users say (or in some cases, are trying to say). DABP 102 provides various different training techniques that can be used by a skill bot designer to train a skill bot, including various machine-learning based training techniques, rules-based training techniques, and/or combinations thereof. In certain examples, a portion (e.g., 80%) of the training data is used to train a skill bot model and another portion (e.g., the remaining 20%) is used to test or verify the model. Once trained, the trained model (also sometimes referred to as the trained skill bot) can then be used to handle and respond to user utterances. In certain cases, a user's utterance may be a question that requires only a single answer and no further conversation. In order to handle such situations, a Q&A (question-and-answer) intent may be defined for a skill bot. This enables a skill bot to output replies to user requests without having to update the dialog definition. Q&A intents are created in a similar manner as regular intents. The dialog flow for Q&A intents can be different from that for regular intents.

(5) Creating a dialog flow for the skill bot—A dialog flow specified for a skill bot describes how the skill bot reacts as different intents for the skill bot are resolved responsive to received user input. The dialog flow defines operations or actions that a skill bot will take, e.g., how the skill bot responds to user utterances, how the skill bot prompts users for input, how the skill bot returns data. A dialog flow is like a flowchart that is followed by the skill bot. The skill bot designer specifies a dialog flow using a language, such as markdown language. In certain embodiments, a version of YAML called OBotML may be used to specify a dialog flow for a skill bot. The dialog flow definition for a skill bot acts as a model for the conversation itself, one that lets the skill bot designer choreograph the interactions between a skill bot and the users that the skill bot services.

In certain examples, the dialog flow definition for a skill bot contains three sections:
(a) a context sections
(b) a default transitions section
(c) states section

Context section—The skill bot designer can define variables that are used in a conversation flow in the context section. Other variables that may be named in the context section include, without limitation: variables for error handling, variables for built-in or custom entities, user variables that enable the skill bot to recognize and persist user preferences, and the like.

Default transitions section—Transitions for a skill bot can be defined in the dialog flow states section or in the default transitions section. The transitions defined in the default transition section act as a fallback and get triggered when there are no applicable transitions defined within a state, or the conditions required to trigger a state transition cannot be met. The default transitions section can be used to define routing that allows the skill bot to gracefully handle unexpected user actions.

States section—A dialog flow and its related operations are defined as a sequence of transitory states, which manage the logic within the dialog flow. Each state node within a dialog flow definition name a component that provides the functionality needed at that point in the dialog. States are thus built around the components. A state contains component-specific properties and defines the transitions to other states that get triggered after the component executes.

Special case scenarios may be handled using the states sections. For example, there might be times when you want to provide users the option to temporarily leave a first skill, they are engaged with to do something in a second skill within the digital assistant. For example, if a user is engaged in a conversation with a shopping skill (e.g., the user has made some selections for purchase), the user may want to jump to a banking skill (e.g., the user may want to ensure that he/she has enough money for the purchase), and then return to the shopping skill to complete the user's order. To address this, an action in the first skill can be configured to initiate an interaction with the second different skill in the same digital assistant and then return to the original flow.

(6) Adding custom components to the skill bot—As described above, states specified in a dialog flow for skill bot name components that provide the functionality needed corresponding to the states. Components enable a skill bot to perform functions. In certain embodiments, DABP 102 provides a set of preconfigured components for performing a wide range of functions. A skill bot designer can select one of more of these preconfigured components and associate them with states in the dialog flow for a skill bot. The skill bot designer can also create custom or new components using tools provided by DABP 102 and associate the custom components with one or more states in the dialog flow for a skill bot.

(7) Testing and deploying the skill bot-DABP 102 provides several features that enable the skill bot designer to test a skill bot being developed. The skill bot can then be deployed and included in a digital assistant.

While the description above describes how to create a skill bot, similar techniques may also be used to create a digital assistant (or the master bot). At the master bot or digital assistant level, built-in system intents may be configured for the digital assistant. These built-in system intents are used to identify general tasks that the digital assistant itself (i.e., the master bot) can handle without invoking a skill bot associated with the digital assistant. Examples of system intents defined for a master bot include: (1) Exit: applies when the user signals the desire to exit the current conversation or context in the digital assistant; (2) Help: applies when the user asks for help or orientation; and (3) Unresolved Intent: applies to user input that doesn't match well with the exit and help intents. The digital assistant also stores information about the one or more skill bots associated with the digital assistant. This information enables the master bot to select a particular skill bot for handling an utterance.

At the master bot or digital assistant level, when a user inputs a phrase or utterance to the digital assistant, the digital assistant is configured to perform processing to determine how to route the utterance and the related conversation. The digital assistant determines this using a routing model, which can be rules-based, AI-based, or a combination thereof. The digital assistant uses the routing model to determine whether the conversation corresponding to the user input utterance is to be routed to a particular skill for handling, is to be handled by the digital assistant or master bot itself per a built-in system intent or is to be handled as a different state in a current conversation flow.

In certain embodiments, as part of this processing, the digital assistant determines if the user input utterance explicitly identifies a skill bot using its invocation name. If an invocation name is present in the user input, then it is treated as explicit invocation of the skill bot corresponding to the invocation name. In such a scenario, the digital assistant may route the user input to the explicitly invoked skill bot for further handling. If there is no specific or explicit invocation, in certain embodiments, the digital assistant evaluates the received user input utterance and computes confidence scores for the system intents and the skill bots associated with the digital assistant. The score computed for a skill bot or system intent represents how likely the user input is representative of a task that the skill bot is configured to perform or is representative of a system intent. Any system intent or skill bot with an associated computed confidence score exceeding a threshold value (e.g., a Confidence Threshold routing parameter) is selected as a candidate for further evaluation. The digital assistant then selects, from the identified candidates, a particular system intent or a skill bot for further handling of the user input utterance. In certain embodiments, after one or more skill bots are identified as candidates, the intents associated with those candidate skills are evaluated (according to the intent model for each skill) and confidence scores are determined for each intent. In general, any intent that has a confidence score exceeding a threshold value (e.g., 70%) is treated as a candidate intent. If a particular skill bot is selected, then the user utterance is routed to that skill bot for further processing. If a system intent is selected, then one or more actions are performed by the master bot itself according to the selected system intent.

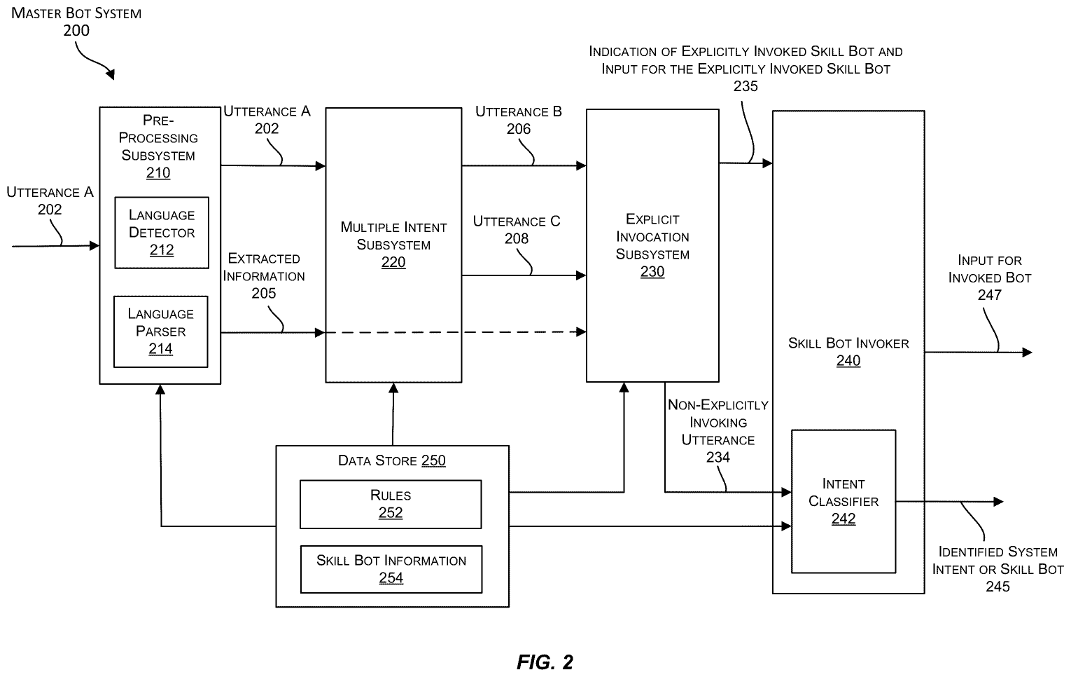

FIG. 2 is a simplified block diagram of a master bot (MB) system 200 according to certain embodiments. MB system 200 can be implemented in software only, hardware only, or a combination of hardware and software. MB system 200 includes a pre-processing subsystem 210, a multiple intent subsystem (MIS) 220, an explicit invocation subsystem (EIS) 230, a skill bot invoker 240, and a data store 250. MB system 200 depicted in FIG. 2 is merely an example of an arrangement of components in a master bot. One of ordinary skill in the art would recognize many possible variations, alternatives, and modifications. For example, in some implementations, MB system 200 may have more or fewer systems or components than those shown in FIG. 2, may combine two or more subsystems, or may have a different configuration or arrangement of subsystems.

Pre-processing subsystem 210 receives an utterance “A” 202 from a user and processes the utterance through a language detector 212 and a language parser 214. As indicated above, an utterance can be provided in various ways including audio or text. The utterance 202 can be a sentence fragment, a complete sentence, multiple sentences, and the like. Utterance 202 can include punctuation. For example, if the utterance 202 is provided as audio, the pre-processing subsystem 210 may convert the audio to text using a speech-to-text converter (not shown) that inserts punctuation marks into the resulting text, e.g., commas, semicolons, periods, etc.

Language detector 212 detects the language of the utterance 202 based on the text of the utterance 202. The manner in which the utterance 202 is handled depends on the language since each language has its own grammar and semantics. Differences between languages are taken into consideration when analyzing the syntax and structure of an utterance.

Language parser 214 parses the utterance 202 to extract part of speech (POS) tags for individual linguistic units (e.g., words) in the utterance 202. POS tags include, for example, noun (NN), pronoun (PN), verb (VB), and the like. Language parser 214 may also tokenize the linguistic units of the utterance 202 (e.g., to convert each word into a separate token) and lemmatize words. A lemma is the main form of a set of words as represented in a dictionary (e.g., “run” is the lemma for run, runs, ran, running, etc.). Other types of pre-processing that the language parser 214 can perform include chunking of compound expressions, e.g., combining “credit” and “card” into a single expression “credit card.” Language parser 214 may also identify relationships between the words in the utterance 202. For example, in some embodiments, the language parser 214 generates a dependency tree that indicates which part of the utterance (e.g., a particular noun) is a direct object, which part of the utterance is a preposition, and so on. The results of the processing performed by the language parser 214 form extracted information 205 and are provided as input to MIS 220 together with the utterance 202 itself.

As indicated above, the utterance 202 can include more than one sentence. For purposes of detecting multiple intents and explicit invocation, the utterance 202 can be treated as a single unit even if it includes multiple sentences. However, in certain embodiments, pre-processing can be performed, e.g., by the pre-processing subsystem 210, to identify a single sentence among multiple sentences for multiple intents analysis and explicit invocation analysis. In general, the results produced by MIS 220 and EIS 230 are substantially the same regardless of whether the utterance 202 is processed at the level of an individual sentence or as a single unit comprising multiple sentences.

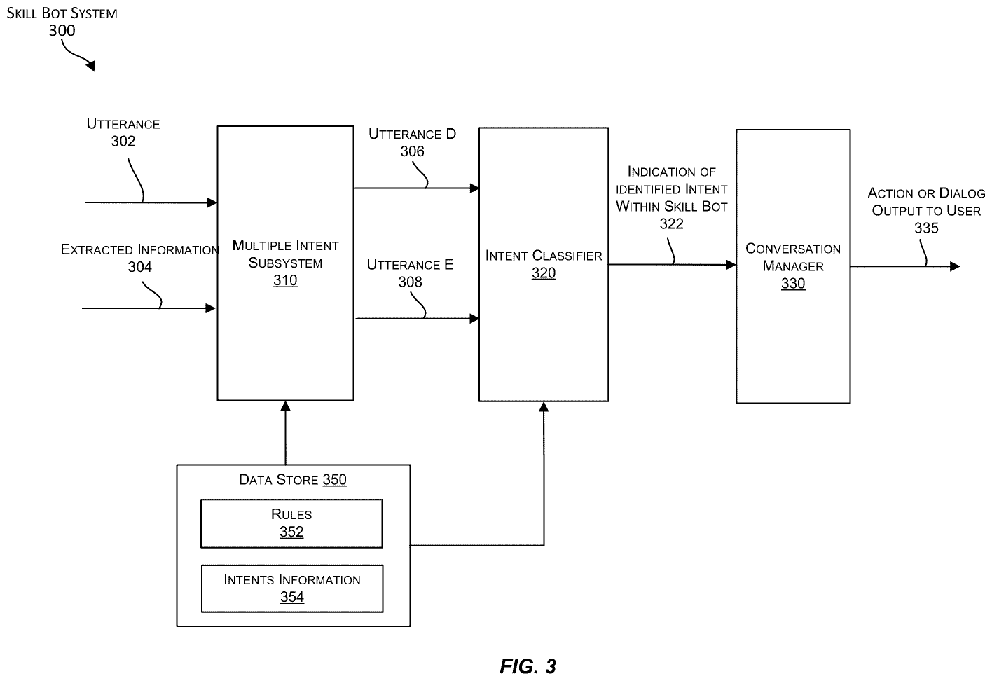

MIS 220 determines whether the utterance 202 represents multiple intents. Although MIS 220 can detect the presence of multiple intents in the utterance 202, the processing performed by MIS 220 does not involve determining whether the intents of the utterance 202 match to any intents that have been configured for a bot. Instead, processing to determine whether an intent of the utterance 202 matches a bot intent can be performed by an intent classifier 242 of the MB system 200 or by an intent classifier of a skill bot (e.g., as shown in FIG. 3). The processing performed by MIS 220 assumes that there exists a bot (e.g., a particular skill bot or the master bot itself) that can handle the utterance 202. Therefore, the processing performed by MIS 220 does not require knowledge of what bots are in the chatbot system (e.g., the identities of skill bots registered with the master bot), or knowledge of what intents have been configured for a particular bot.

To determine that the utterance 202 includes multiple intents, the MIS 220 applies one or more rules from a set of rules 252 in the data store 250. The rules applied to the utterance 202 depend on the language of the utterance 202 and may include sentence patterns that indicate the presence of multiple intents. For example, a sentence pattern may include a coordinating conjunction that joins two parts (e.g., conjuncts) of a sentence, where both parts correspond to a separate intent. If the utterance 202 matches the sentence pattern, it can be inferred that the utterance 202 represents multiple intents. It should be noted that an utterance with multiple intents does not necessarily have different intents (e.g., intents directed to different bots or to different intents within the same bot). Instead, the utterance could have separate instances of the same intent (e.g., “Place a pizza order using payment account X, then place a pizza order using payment account Y”).

As part of determining that the utterance 202 represents multiple intents, the MIS 220 also determines what portions of the utterance 202 are associated with each intent. MIS 220 constructs, for each intent represented in an utterance containing multiple intents, a new utterance for separate processing in place of the original utterance, e.g., an utterance “B” 206 and an utterance “C” 208, as depicted in FIG. 2. Thus, the original utterance 202 can be split into two or more separate utterances that are handled one at a time. MIS 220 determines, using the extracted information 205 and/or from analysis of the utterance 202 itself, which of the two or more utterances should be handled first. For example, MIS 220 may determine that the utterance 202 contains a marker word indicating that a particular intent should be handled first. The newly formed utterance corresponding to this particular intent (e.g., one of utterance 206 or utterance 208) will be the first to be sent for further processing by EIS 230. After a conversation triggered by the first utterance has ended (or has been temporarily suspended), the next highest priority utterance (e.g., the other one of utterance 206 or utterance 208) can then be sent to the EIS 230 for processing.

EIS 230 determines whether the utterance that it receives (e.g., utterance 206 or utterance 208) contains an invocation name of a skill bot. In certain embodiments, each skill bot in a chatbot system is assigned a unique invocation name that distinguishes the skill bot from other skill bots in the chatbot system. A list of invocation names can be maintained as part of skill bot information 254 in data store 250. An utterance is deemed to be an explicit invocation when the utterance contains a word match to an invocation name. If a bot is not explicitly invoked, then the utterance received by the EIS 230 is deemed a non-explicitly invoking utterance 234 and is input to an intent classifier (e.g., intent classifier 242) of the master bot to determine which bot to use for handling the utterance. In some instances, the intent classifier 242 will determine that the master bot should handle a non-explicitly invoking utterance. In other instances, the intent classifier 242 will determine a skill bot to route the utterance to for handling.

The explicit invocation functionality provided by the EIS 230 has several advantages. It can reduce the amount of processing that the master bot has to perform. For example, when there is an explicit invocation, the master bot may not have to do any intent classification analysis (e.g., using the intent classifier 242), or may have to do reduced intent classification analysis for selecting a skill bot. Thus, explicit invocation analysis may enable selection of a particular skill bot without resorting to intent classification analysis.

Also, there may be situations where there is an overlap in functionalities between multiple skill bots. This may happen, for example, if the intents handled by the two skill bots overlap or are very close to each other. In such a situation, it may be difficult for the master bot to identify which of the multiple skill bots to select based upon intent classification analysis alone. In such scenarios, the explicit invocation disambiguates the particular skill bot to be used.

In addition to determining that an utterance is an explicit invocation, the EIS 230 is responsible for determining whether any portion of the utterance should be used as input to the skill bot being explicitly invoked. In particular, EIS 230 can determine whether part of the utterance is not associated with the invocation. The EIS 230 can perform this determination through analysis of the utterance and/or analysis of the extracted information 205. EIS 230 can send the part of the utterance not associated with the invocation to the invoked skill bot in lieu of sending the entire utterance that was received by the EIS 230. In some instances, the input to the invoked skill bot is formed simply by removing any portion of the utterance associated with the invocation. For example, “I want to order pizza using Pizza Bot” can be shortened to “I want to order pizza” since “using Pizza Bot” is relevant to the invocation of the pizza bot, but irrelevant to any processing to be performed by the pizza bot. In some instances, EIS 230 may reformat the part to be sent to the invoked bot, e.g., to form a complete sentence. Thus, the EIS 230 determines not only that there is an explicit invocation, but also what to send to the skill bot when there is an explicit invocation. In some instances, there may not be any text to input to the bot being invoked. For example, if the utterance was “Pizza Bot,” then the EIS 230 could determine that the pizza bot is being invoked, but there is no text to be processed by the pizza bot. In such scenarios, the EIS 230 may indicate to the skill bot invoker 240 that there is nothing to send.

Skill bot invoker 240 invokes a skill bot in various ways. For instance, skill bot invoker 240 can invoke a bot in response to receiving an indication 235 that a particular skill bot has been selected as a result of an explicit invocation. The indication 235 can be sent by the EIS 230 together with the input for the explicitly invoked skill bot. In this scenario, the skill bot invoker 240 will turn control of the conversation over to the explicitly invoked skill bot. The explicitly invoked skill bot will determine an appropriate response to the input from the EIS 230 by treating the input as a stand-alone utterance. For example, the response could be to perform a specific action or to start a new conversation in a particular state, where the initial state of the new conversation depends on the input sent from the EIS 230.

Another way in which skill bot invoker 240 can invoke a skill bot is through implicit invocation using the intent classifier 242. The intent classifier 242 can be trained, using machine-learning and/or rules-based training techniques, to determine a likelihood that an utterance is representative of a task that a particular skill bot is configured to perform. The intent classifier 242 is trained on different classes, one class for each skill bot. For instance, whenever a new skill bot is registered with the master bot, a list of example utterances associated with the new skill bot can be used to train the intent classifier 242 to determine a likelihood that a particular utterance is representative of a task that the new skill bot can perform. The parameters produced as result of this training (e.g., a set of values for parameters of a machine-learning model) can be stored as part of skill bot information 254.

In certain embodiments, the intent classifier 242 is implemented using a machine-learning model, as described in further detail herein. Training of the machine-learning model may involve inputting at least a subset of utterances from the example utterances associated with various skill bots to generate, as an output of the machine-learning model, inferences as to which bot is the correct bot for handling any particular training utterance. For each training utterance, an indication of the correct bot to use for the training utterance may be provided as ground truth information. The behavior of the machine-learning model can then be adapted (e.g., through back-propagation) to minimize the difference between the generated inferences and the ground truth information.

In certain embodiments, the intent classifier 242 determines, for each skill bot registered with the master bot, a confidence score indicating a likelihood that the skill bot can handle an utterance (e.g., the non-explicitly invoking utterance 234 received from EIS 230). The intent classifier 242 may also determine a confidence score for each system level intent (e.g., help, exit) that has been configured. If a particular confidence score meets one or more conditions, then the skill bot invoker 240 will invoke the bot associated with the particular confidence score. For example, a threshold confidence score value may need to be met. Thus, an output 245 of the intent classifier 242 is either an identification of a system intent or an identification of a particular skill bot. In some embodiments, in addition to meeting a threshold confidence score value, the confidence score must exceed the next highest confidence score by a certain win margin. Imposing such a condition would enable routing to a particular skill bot when the confidence scores of multiple skill bots each exceed the threshold confidence score value.

After identifying a bot based on evaluation of confidence scores, the skill bot invoker 240 hands over processing to the identified bot. In the case of a system intent, the identified bot is the master bot. Otherwise, the identified bot is a skill bot. Further, the skill bot invoker 240 will determine what to provide as input 247 for the identified bot. As indicated above, in the case of an explicit invocation, the input 247 can be based on a part of an utterance that is not associated with the invocation, or the input 247 can be nothing (e.g., an empty string). In the case of an implicit invocation, the input 247 can be the entire utterance.

Data store 250 comprises one or more computing devices that store data used by the various subsystems of the master bot system 200. As explained above, the data store 250 includes rules 252 and skill bot information 254. The rules 252 include, for example, rules for determining, by MIS 220, when an utterance represents multiple intents and how to split an utterance that represents multiple intents. The rules 252 further include rules for determining, by EIS 230, which parts of an utterance that explicitly invokes a skill bot to send to the skill bot. The skill bot information 254 includes invocation names of skill bots in the chatbot system, e.g., a list of the invocation names of all skill bots registered with a particular master bot. The skill bot information 254 can also include information used by intent classifier 242 to determine a confidence score for each skill bot in the chatbot system, e.g., parameters of a machine-learning model.

FIG. 3 is a simplified block diagram of a skill bot system 300 according to certain embodiments. Skill bot system 300 is a computing system that can be implemented in software only, hardware only, or a combination of hardware and software. In certain embodiments such as the embodiment depicted in FIG. 1, skill bot system 300 can be used to implement one or more skill bots within a digital assistant.

Skill bot system 300 includes an MIS 310, an intent classifier 320, and a conversation manager 330. The MIS 310 is analogous to the MIS 220 in FIG. 2 and provides similar functionality, including being operable to determine, using rules 352 in a data store 350: (1) whether an utterance represents multiple intents and, if so, (2) how to split the utterance into a separate utterance for each intent of the multiple intents. In certain embodiments, the rules applied by MIS 310 for detecting multiple intents and for splitting an utterance are the same as those applied by MIS 220. The MIS 310 receives an utterance 302 and extracted information 304. The extracted information 304 is analogous to the extracted information 205 in FIG. 1 and can be generated using the language parser 214 or a language parser local to the skill bot system 300.

Intent classifier 320 can be trained in a similar manner to the intent classifier 242 discussed above in connection with the embodiment of FIG. 2 and as described in further detail herein. For instance, in certain embodiments, the intent classifier 320 is implemented using a machine-learning model. The machine-learning model of the intent classifier 320 is trained for a particular skill bot, using at least a subset of example utterances associated with that particular skill bot as training utterances. The ground truth for each training utterance would be the particular bot intent associated with the training utterance.

The utterance 302 can be received directly from the user or supplied through a master bot. When the utterance 302 is supplied through a master bot, e.g., as a result of processing through MIS 220 and EIS 230 in the embodiment depicted in FIG. 2, the MIS 310 can be bypassed so as to avoid repeating processing already performed by MIS 220. However, if the utterance 302 is received directly from the user, e.g., during a conversation that occurs after routing to a skill bot, then MIS 310 can process the utterance 302 to determine whether the utterance 302 represents multiple intents. If so, then MIS 310 applies one or more rules to split the utterance 302 into a separate utterance for each intent, e.g., an utterance “D” 306 and an utterance “E” 308. If utterance 302 does not represent multiple intents, then MIS 310 forwards the utterance 302 to intent classifier 320 for intent classification and without splitting the utterance 302.

Intent classifier 320 is configured to match a received utterance (e.g., utterance 306 or 308) to an intent associated with skill bot system 300. As explained above, a skill bot can be configured with one or more intents, each intent including at least one example utterance that is associated with the intent and used for training a classifier. In the embodiment of FIG. 2, the intent classifier 242 of the master bot system 200 is trained to determine confidence scores for individual skill bots and confidence scores for system intents. Similarly, intent classifier 320 can be trained to determine a confidence score for each intent associated with the skill bot system 300. Whereas the classification performed by intent classifier 242 is at the bot level, the classification performed by intent classifier 320 is at the intent level and therefore finer grained. The intent classifier 320 has access to intents information 354. The intents information 354 includes, for each intent associated with the skill bot system 300, a list of utterances that are representative of and illustrate the meaning of the intent and are typically associated with a task performable by that intent. The intents information 354 can further include parameters produced as a result of training on this list of utterances.

Conversation manager 330 receives, as an output of intent classifier 320, an indication 322 of a particular intent, identified by the intent classifier 320, as best matching the utterance that was input to the intent classifier 320. In some instances, the intent classifier 320 is unable to determine any match. For example, the confidence scores computed by the intent classifier 320 could fall below a threshold confidence score value if the utterance is directed to a system intent or an intent of a different skill bot. When this occurs, the skill bot system 300 may refer the utterance to the master bot for handling, e.g., to route to a different skill bot. However, if the intent classifier 320 is successful in identifying an intent within the skill bot, then the conversation manager 330 will initiate a conversation with the user.

The conversation initiated by the conversation manager 330 is a conversation specific to the intent identified by the intent classifier 320. For instance, the conversation manager 330 may be implemented using a state machine configured to execute a dialog flow for the identified intent. The state machine can include a default starting state (e.g., for when the intent is invoked without any additional input) and one or more additional states, where each state has associated with it actions to be performed by the skill bot (e.g., executing a purchase transaction) and/or dialog (e.g., questions, responses) to be presented to the user. Thus, the conversation manager 330 can determine an action/dialog 335 upon receiving the indication 322 identifying the intent and can determine additional actions or dialog in response to subsequent utterances received during the conversation.

Data store 350 comprises one or more computing devices that store data used by the various subsystems of the skill bot system 300. As depicted in FIG. 3, the data store 350 includes the rules 352 and the intents information 354. In certain embodiments, data store 350 can be integrated into a data store of a master bot or digital assistant, e.g., the data store 250 in FIG. 2.

### Converting A Natural Language Utterance To A Logical Form

A NL2LF system (such as C2OMRL) system is powered by a deep learning model configured to convert a natural language (NL) utterance (e.g., a query posed by a user using a digital assistant or chatbot) into a LF, for example, an intermediate database query language such as OMRL. The LF can be used to generate a query in a specific system query language (e.g., SQL), which can then be executed for querying a system such as a database to obtain an answer to the user's utterance.

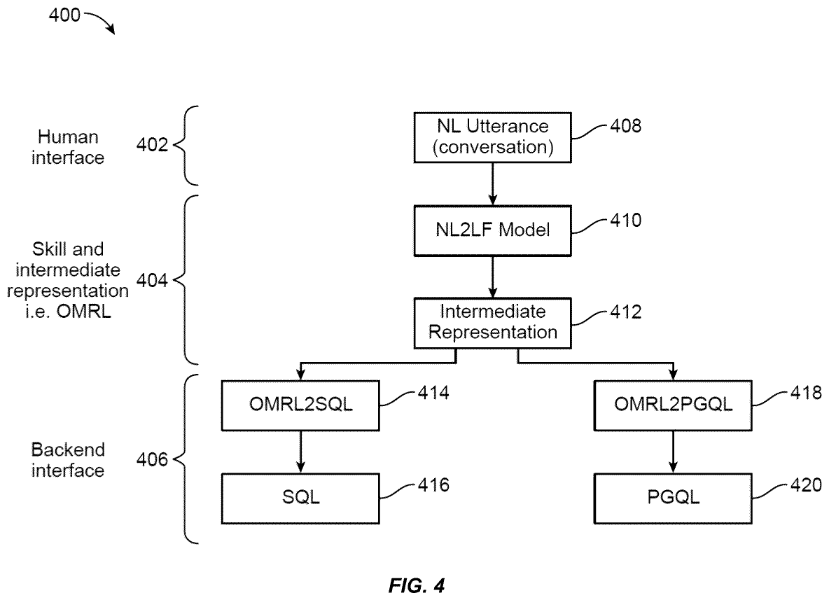

FIG. 4 is a block diagram 400 illustrating an overview of a C20MRL architecture and process for generating a query for a backend interface 406 starting with a NL utterance 408, e.g., as received via a human interface 402. For example, the human interface 402 can be a chatbot system that receives spoken speech and translates it to a text utterance, as described above, or a system where a user types in a request in natural language, or other suitable interfaces. The NL utterance 408 can be in the form of part of a conversation (e.g., “Hello, can you tell me how many orders we need to send out tomorrow?” or “Search for all employees with first name starting with ‘S’ and living in California.”).

The NL utterance 408 is provided to a NL2LF model 410, which converts the NL utterance 408 to an intermediate representation 412 (e.g., MRL or OMRL). The NL2LF model 410 is a machine learning model trained to generate intermediate representations 412 from NL utterances 408. The NL2LF model 410 includes multiple layers and algorithms for generating intermediate representations 412 from NL utterances 408, as described herein in further detail. In some instances, as depicted in FIG. 4, the NL2LF model 410 is a C2OMRL model for converting a conversational utterance to OMRL 412. The NL2LF model 410 may be described interchangeably herein with C2OMRL, although it should be understood that the techniques described herein can be applied to models configured to generate other intermediate representation 412 formats. The intermediate representation 412 is a logical representation of the utterance, which is configured to be translatable into a specific system query language. In some examples, the intermediate representation 412 is OMRL, an intermediate database query language with a specialized schema and interface specification. The intermediate representation 412 may be described interchangeably herein with OMRL, although it should be understood that the techniques described herein can be applied to other intermediate representation 412 formats.

The intermediate representation 412 can then be translated to one or more desired system query languages, such as SQL 416, PGQL 420, OAC Backend (not shown), using one or more system language translation processes, such as an OMRL2SQL 414 translation process, an OMRL2PGQL 418 translation process, or an OMRL20AC translation process (not shown). The translated query (e.g., SQL 416, PGQL 420, or OAC Backend) represents the concepts that are present in intermediate representation 412 in a manner that conforms to the requirements of the applicable system query language.

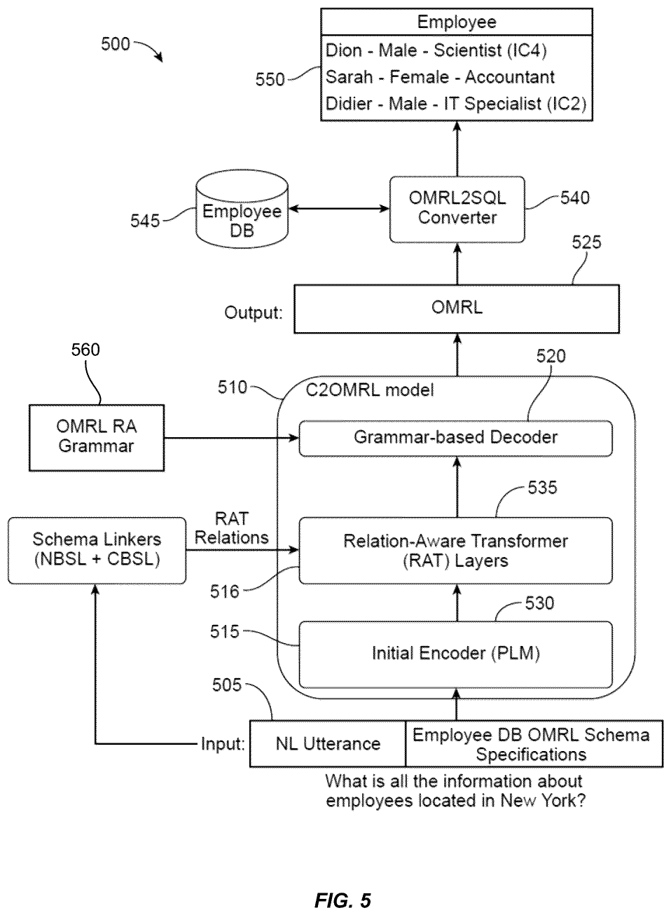

FIG. 5 shows a C2OMRL system 500 powered by a machine learning model to be able to convert a NL utterance (e.g., an utterance within the Digital Assistant platform as described with respect to FIGS. 1-3) into a LF statement such as OMRL query or command, which in turn can be executed for querying an existing system such as a relational database. This machine learning model (referred to herein as the “C2OMRL semantic parser” or “C20MRL model” or simply “parser”) is trained on hundreds to thousands of annotated example pairs (natural language and logical form pairs) for translating NL utterance into a LF statement. As shown in FIG. 5, an example 505 (concatenation of a natural language utterance and the database schema, e.g., sequence of table and column names) is input into the C2OMRL model 510. The example 505 is first processed by the encoder component 515, which captures the representation of the natural language utterance and the database schema contextually. The decoder 520 then receives the encoded input and predicts the logical form 525 (e.g., OMRL, which is a SQL-like statement or query) based on the captured representation of the natural language utterance and the database schema.

In the C2OMRL model 510, the encoder component 515 includes two encoders (1) a first encoder, which is a Pre-trained Language Model (PLM) 530; and (2) a second encoder, which is a Relation-Aware Transformer (RAT) 535. The PLM 530 is used to embed the natural language utterance and database schema, as it captures a representation of the natural language utterance and the database schema contextually. In certain instances, a transformer-based PLM called Decoding-enhanced BERT with disentangled attention (DeBERTa) is used as the PLM 530. (See He et al., DeBERTaV3: Improving DeBERTa using ELECTRA-Style Pre-Training with Gradient-Disentangled Embedding Sharing (2021), the entire contents of which are hereby incorporated by reference for all purposes). Transformer-based PLMs learn universal language representations from large volumes of text data using self-supervised learning and transfer this knowledge to downstream tasks. These models provide good background knowledge to downstream tasks which avoids training of downstream models from scratch. The RAT 535 encodes the relations between entities in the database schema and words in the natural language utterance (these relations are called “schema linking” relations). Use of RATs is described in Wang et al., RAT-SQL: Relation-Aware Schema Encoding and Linking for Text-to-SQL Parsers (2021), the entire contents of which is incorporated herein by reference for all purposes.

The decoder 520 is based on a bottom-up generative process (i.e., the bottom-up generative process generates a tree from left to right), where the final generation output is a OMRL tree (i.e., a tree-based structure that represents the full OMRL logical form) that can be mapped to a final OMRL logical form 525. The bottom-up generative process is implemented using a beam search, which is a heuristic search algorithm that explores a graph by expanding the most promising node in a limited set. The beam search works in steps (e.g., ˜10 steps), also called “beam levels”. At each step (e.g., “step i”), the beam search algorithm generates a number F of possible sub-trees for an input sequence that can be obtained by extending the current sub-trees (from step “i−1”), and then selects the top-K sub-trees (known as beam width) for retention using the conditional probability associated with each sub-tree. The conditional probability is referred to herein as a “raw beam score”, and thus the top-K intermediate results (to be considered in the next generative step) are the K ones with the highest raw beam scores. Additional information for the bottom-up generative process is found in “Ohad Rubin and Jonathan Berant. 2021. SmBoP: Semi-autoregressive Bottom-up Semantic Parsing, in Proceedings of the 2021 Conference of the North American Chapter of the Association for Computational Linguistics: Human Language Technologies, pages 311-324, Online. Association for Computational Linguistics,” the entire contents of which is hereby incorporated by reference for all purposes. The final decoder 520 output is the sub-tree with the highest raw beam score at the last step N.

For example, at a first step (beam level 1), the encoded input utterance and database schema are input to the decoder 520 and the decoder 520 will apply a SoftMax function to all the tokens in a vocabulary or grammar 560 to find the best alternatives for a first sub-tree (e.g., a first token or node of a tree). To generate the number F of possible sub-trees (known as the frontier), the decoder 520 makes predictions representing the conditional probability of each token in the vocabulary or grammar 560 coming next in a sequence (the likely value of yi+1, conditioned on the previous tokens y₁, . . . , yi and the context variable c, produced by the encoder to represent the input sequence). The vocabulary or grammar 560 is obtained from a corpus comprising words or terms in the target logical form (e.g., OMRL). In certain instances, the corpus further comprises rules for the words or terms in the target logical form. The rules define how the words or terms may be used to create a proper phrase or operation in the target logical form (e.g., the combination of terms that work together for a proper OMRL query). The beam search algorithm then selects the top-K sub-trees with the highest conditional probability or raw beam score as the most likely possible choices for the time step. In this example, suppose the top-K sub-trees or beam width is 2 and that the sub-trees with the highest conditional probabilities P (y₁|c) in the first step are sub-tree_1 and sub-tree_12. The top-K results can be a selectable and/or optimizable hyperparameter. Sub-tree_1 and sub-tree_12 and the corresponding conditional probabilities or raw beam scores are saved in memory.

At a second step (beam level 2), the two selected trees (sub-tree_1 and sub-tree_12) from the first step are input to the decoder 520 and the decoder 520 will apply the softmax function to all the tokens in the vocabulary or grammar 560 to find the two best alternatives for the second sub-tree (e.g., a first and second token or node of a tree). While doing this, the beam search algorithm will determine the combination of the first and second tokens or nodes that are most likely to form a pair or second sub-tree using the conditional probabilities. In other words, for all y₂∈Y, the beam search algorithm computes P(sub-tree_1,y₂|c)=P(sub-tree_1|c)P(y₂|sub-tree_1,c), P(sub-tree_12,y₂|c)=P(sub-tree_12|c)P(y₂|sub-tree_12,c), and select the largest two among these values, for example P(sub-tree_22|c) and P(sub-tree_37|c). Sub-tree_22 and sub-tree_37 and the corresponding conditional probabilities or raw beam scores are saved in memory.

At a third step (beam level 3), the two selected trees (sub-tree_22 and sub-tree_37) from the second step are input to the decoder 520 and the decoder 520 will apply the softmax function to all the tokens in the vocabulary or grammar 560 to find the two best alternatives for the third sub-tree (e.g., a first, second, and third token or node of a tree). While doing this, the beam search algorithm will determine the combination of the first, second, and third tokens or nodes that are most likely to form a string or third sub-tree using the conditional probabilities. In other words, for all y₃∈Y, the beam search algorithm computes P(sub-tree_22,y₃|c)=P(sub-tree_22|c)P(y₃|sub-tree_22,c), P(sub-tree_37,y₃|c)=P(sub-tree_37|c)P(y₃|sub-tree_37,c), and select the top-K sub-trees. The top-K sub-trees and the corresponding conditional probabilities or raw beam scores are saved in memory. This process continues until N number of beam levels is completed (this could be an optimized or selected hyperparameter). The final model output is the sub-tree with the highest conditional probability or raw beam score at the last step N (beam level N). The tokens or nodes of this final sub-tree can then be mapped to a final logical form such as OMRL logical form statement 525.

In some implementations, the vocabulary or grammar 560 is a relational algebra (RA) grammar. As discussed above, the vocabulary or grammar 560 is used by the decoder 520 to represent the logical form query as a tree. In the case of a RA grammar, the RA grammar includes configured RA operators which are used by the decoder 520 to represent the intermediate database query representation (i.e., the logical form query) as a tree. The RA grammar controls the syntax of the decoder 520 output to ensure that the generated logical form will have proper syntax, which will influence the processing steps later (including execution over existing databases). Thus, the LF is further based on the RA grammar. In some implementations, the RA grammar is adapted for OMRL. An example of a RA grammar for OMRL is shown in Table 3, where P is the predicate, R is the relation, C is the schema constant or database value, and C′ is a set of constants/values and aggregates (e.g., sum/maximum/minimum/count/average).

TABLE 3

| | Operator | Input → Output |
|---|---|---|
| 1 | Set Union | R × R → R |
| 2 | Set Intersection | R × R → R |
| 3 | Set Difference | R × R → R |
| 4 | Selection | P × R → R |
| 5 | Cartesian Product | R × R → R |
| 6 | Projection | C′ × R → R |
| 7 | And | P × P → P |
| 8 | Or | P × P → P |
| 9 | Comparison | C × C → P |
| 10 | Constant Union | C′ × C′ → C′ |
| 11 | Order by | C × R → R |
| 12 | Group by | C′ × R → R |
| 13 | Limit | C′ × R → R |
| 14 | In/Not In | C′ × R → P |
| 15 | Like/Not Like | C × C → P |
| 16 | Like Start/Not Like Start | C × C → P |
| 17 | Like End/Not Like End | C × C → P |
| 18 | Aggregation | C → C |
| 19 | Distinct | C → C |
| 20 | Keep | Any → Any |

The predicted MRL logical form statement 525 (i.e., the OMRL tree with the highest raw beam score at the last step N) can then be input into a language converter 540 such as (OMRL2SQL) to translate the meaning representation to a systems language query or command such as SQL, APIs, REST, GraphQL, PGQL, etc. The systems language query or command can then be used to query or execute an operation on a system 545 (e.g., a relational database) and obtain an output 550 as a result of the query or command.

### Managing Date-Time Intervals

As discussed above, when transforming NL utterances that involve date-time intervals to LFs, the types of the date-time intervals may not be identified and/or may be incorrectly or inaccurately reflected in the LFs. As a result, any date-time interval(s) included in the LF may be misleading and/or may not facilitate the desired downstream results. One option to support date-time intervals in NL2LF systems would be to extend the database schema provided with the input NL utterance to the NL2LF system with additional “derived attributes” for each of the date-time attributes in the database schema such that all potential date-time intervals for each date-time attribute are supported. However, this option can lead to much larger database schemas, which in turn can result in longer model training times and model prediction latencies and increase the chances of attribute confusion since the input to the NL2LF system may include many similar attributes with partially overlapping names being input together.

The techniques described herein address these challenges and others by supporting techniques for managing cases involving binning over a date-time interval and techniques for managing cases involving filtering over date-time interval. To support the techniques for managing cases involving binning over date-time intervals, the grammar of the NL2LF model is enhanced to support date-time extraction functions while generating the raw model prediction. Also, training examples (e.g., tuples of an NL utterance, the OMRQL for the NL utterance, and database schema) are augmented to diversify the date-time function(s) in the LFs of the training examples as well as the corresponding date-time mention(s) in the NL utterances of the training examples. To support the techniques for managing cases involving filtering over date-time intervals, raw model predictions that include filter conditions followed by date-time attributes are transformed into final model predictions in which the date-time attributes are transformed into date-time extraction functions corresponding to the date-time attributes. The techniques described herein enables the date-time intervals in the output LFs to provide more information regarding the date-time intervals in the NL utterances, which is beneficial for use by downstream systems such as analytics platforms. Additionally, with the techniques described herein negative impacts and confusion in downstream tasks can be avoided and query accuracy and execution, data retrieval and visualization, result accuracy, and the like can be improved.

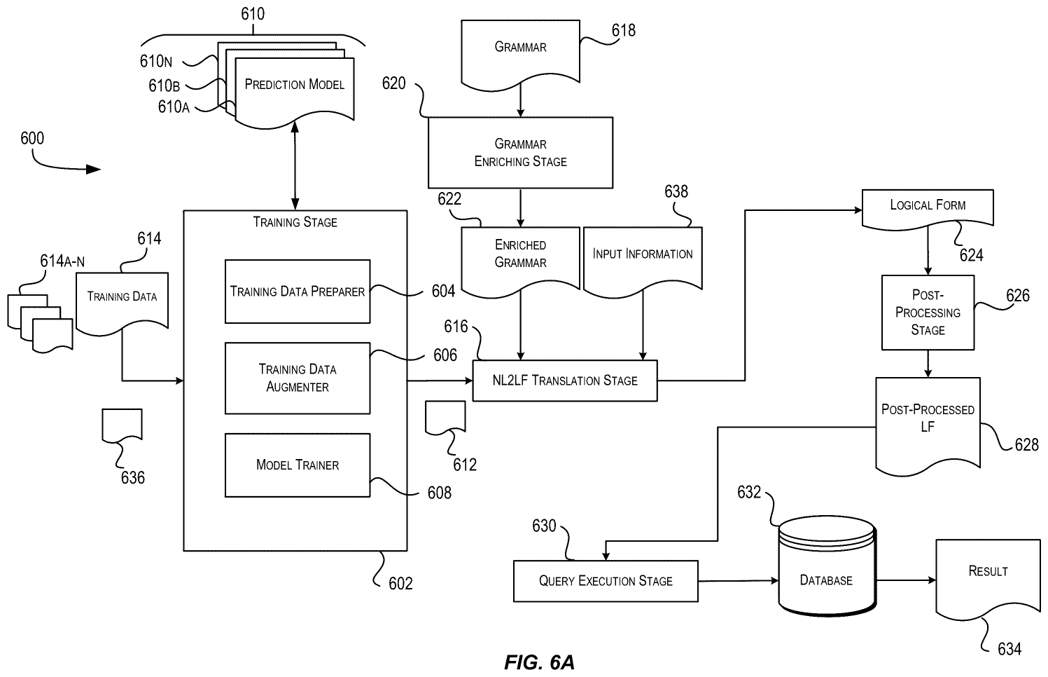

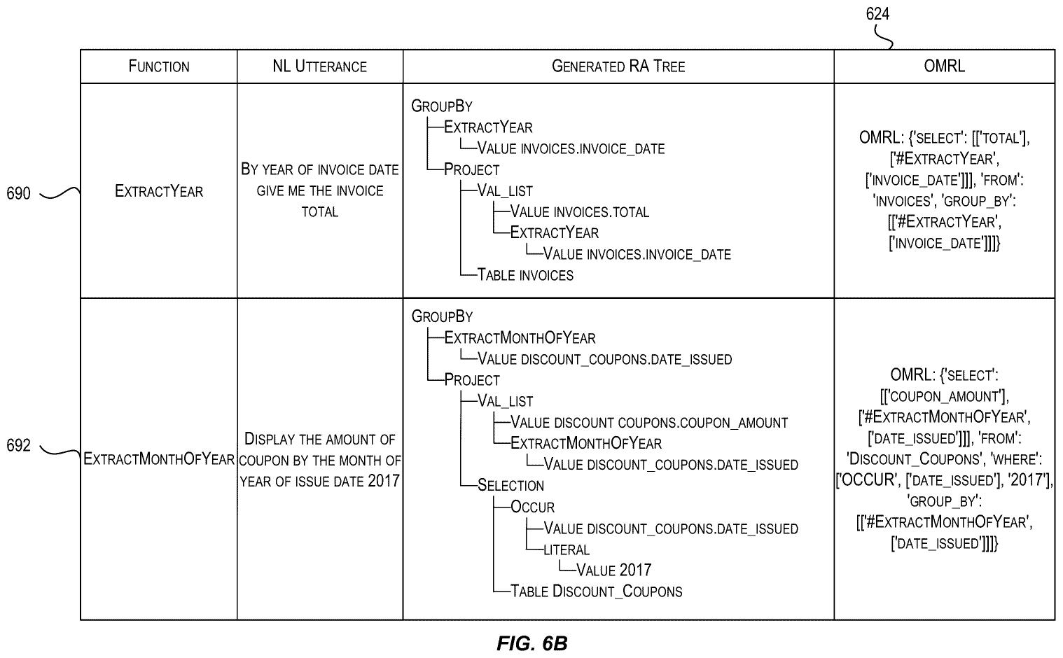

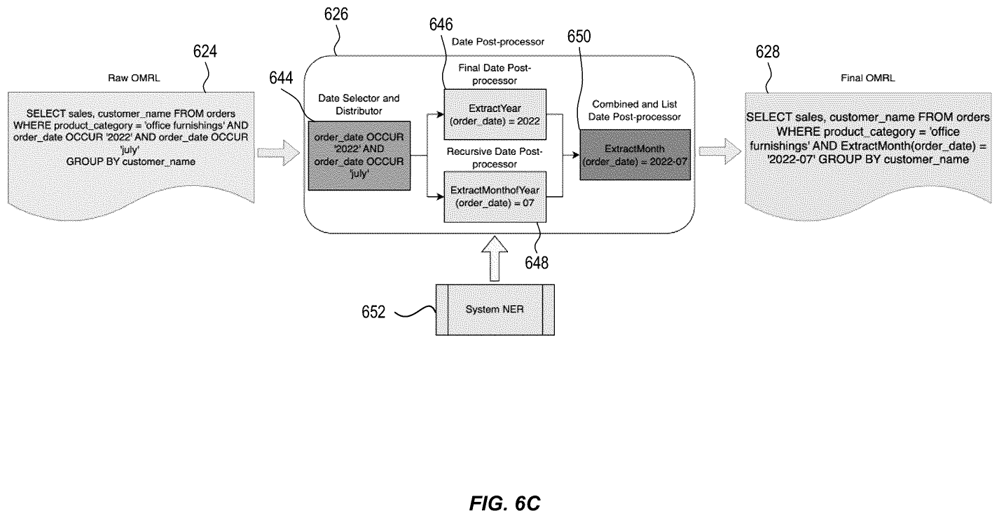

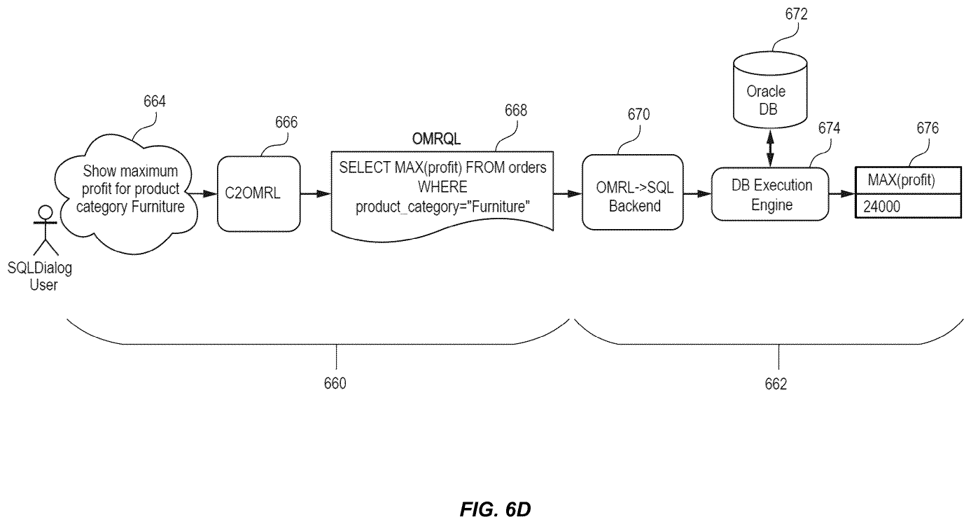

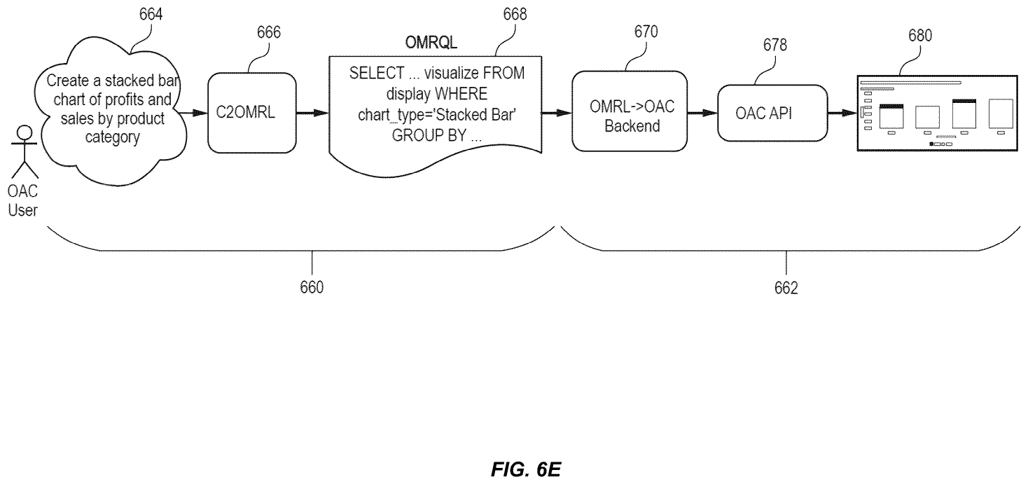

FIG. 6A is a simplified block diagram of an example of a system for training, providing, and using machine learning models that can manage date-time intervals in transforming NL utterances to LFs. As shown in FIG. 6A, the system 600A in this example includes various stages: a training stage 602 to train and provide trained machine learning models, a NL2LF translation stage 616 to translate NL utterances to LFs using a trained machine learning model provided by the training stage 602, a grammar enriching stage 620 to enrich a grammar 618 and provide an enriched grammar 622 to the NL2LF translation stage 616, a post-processing stage 626 to process LFs translated by the NL2LF translation stage 616, and a query execution stage 630 to execute post-processed LFs. In some implementations, although not shown, the training stage 602 can be included a training system or subsystem of the system 600A and the NL2LF translation stage 616, the grammar enriching stage 620, the post-processing stage 626, and the query execution stage 630 can be part of a query execution system or subsystem of the system 600A.

The training stage 602 builds and trains machine learning models 610A-610N (‘N’ represents any natural number) to be used by the other stages (which may be referred to herein individually as model 610 or collectively as models 610). An example of a model 610 built and trained by the training stage 602 is NL2LF model 612. Each of the models 610, including the NL2LF model 612, can be any suitable machine learning model that is built and trained to process and understand NL and perform other tasks based on NL such as transforming a NL utterance into a LF such as OMRL, recognizing named entities, and the like. Each of the models 610, including the NL2LF model 612, can be and/or based on the NL2LF model 410, the C20MRL model 510, a large language model, a pre-trained language model, a semantic parser, a combination thereof, and the like. Additionally, each of the models 610, including the NL2LF model 612, can be built and/or trained based on one or more architectures such as transformer architectures, encoder-decoder architectures, encoder only architectures, decoder only architectures, a combination thereof, and the like.

To train the models 610, the training stage 602 includes various components such as training data preparer 604, training data augmenter 606, and model trainer 608. The training data preparer 604 facilitates the process of loading training data 614, splitting the training data 614 into training and validation sets (614A-N) so that the system can train and test the models 610, and performing basic natural language pre-processing (e.g., standardization, normalization, tokenizing data, annotation, augmentation, embedding, etc.). The training data 614 includes training examples. One or more training examples of the training data 614 includes tuples of an NL utterance, a LF corresponding to the NL utterance (e.g., a NL utterance and an OMRL representation of the NL utterance), and database schema information corresponding to the NL utterance and the LF. In some implementations, one or more training examples of the training data 614 can be associated with a “binning over date-time” feature. A training example that is associated with a “binning over date-time” feature includes tuples of an NL utterance that references a binning operation over a particular date-time interval, a LF that corresponds to the NL utterance and includes a date-time extraction function pertaining to the particular date-time interval, and database schema information corresponding to the NL utterance and the LF. The LF of a respective training example including a training example that is associated with a “binning over date-time feature” can serve as ground truth information for that respective training example. Additionally, the database schema information of a respective training example including a training example that is associated with a “binning over date-time feature” can correspond to an example database that can be queried using the NL utterance and LF of the respective training example. An example of a training example that is associated with a “binning over date-time” feature is shown in Table 4.

TABLE 4

| Schema | | | | |
|---|---|---|---|---|
| Schema_ID | Table(s) | Attributes | NL Utterance | OMRL Logical Form |
| Superstore_1 | Orders | Sales; Profit | Show maximum profit | SELECT MAX(Profit), |
| | | Order_Date; | by orders' month of | ExtractMonthOfYear |
| | | Ship_Date; | the year | (Order_Date) FROM |
| | | Category; | | Orders GROUP BY |
| | | Carrier | | ExtractMonthOfYear |
| | | | | (Order_Date) |

Examples of date-time intervals include year, quarter, quarter of year, month, month of year, week, week of year, day of week (weekday), day, day of year, day of month, hour, hour of day, minute, second, millisecond, and others. As described above, a training example that is associated with a “binning over date-time” feature includes an NL utterance that references a binning operation over a particular date-time interval and a LF that corresponds to the NL utterance and includes a date-time extraction function pertaining to the particular date-time interval. An NL utterance that references a binning operation over a particular date-time interval includes a word or sequence of words (i.e., a keyword) that correspond to the particular date-time interval referenced by the NL utterance. For example, as shown in Table 4 above, for a training example that includes the NL utterance “show maximum profit by orders' month of the year,” the sequence of words “month of the year” corresponds to the date-time interval “month of year.” As such, the NL utterance shown in Table 4 is an NL utterance of a training example that is associated with a “binning over date-time” feature. Each NL utterance that references a binning operation over a particular date-time interval can be labeled with a date-time interval label that identifies the word or sequence of words that correspond to the particular date-time interval referenced by that NL utterance and the particular date-time interval that is referenced (e.g., sequence of words “month of the year” and label “Month Of Year”). A LF that corresponds to an NL utterance that references binning operation over a particular date-time interval includes a date-time extraction function that corresponds to that particular date-time interval. The date-time extraction function corresponding to a particular date-time interval can be configured to extract information (e.g., from a database to be searched) covering that particular date-time interval. For example, as shown in Table 4 above, for a training example that includes the OMRL Logical Form “SELECT MAX (Profit), ExtractMonthOfYear (Order_Date) FROM Orders GROUP BY ExtractMonthOfYear (Order_Date),” the “ExtractMonthOfYear” date-time extraction function, which is configured to extract information from the “Order Date” attribute of an “Orders” table in a database, corresponds to the “month of the year” date-time interval of its corresponding NL utterance. Each LF that includes a date-time extraction function can be labeled with a label that identifies the name of the date-time extraction function (e.g., “ExtractMonthOfYear” and label “Month of Year”).

The date-time extraction function can belong to a set of date-time extraction functions. At least one training example can be provided for each date-time extraction function of the set of date-time extraction functions. For example, a first training example that is associated with a “binning over date-time” feature can include an NL utterance that references a binning operation over a particular date-time interval corresponding to a first date-time extraction function of the set of date-time extraction functions and a LF that corresponds to the NL utterance and includes the first date-time extraction function. In another example, a second training example that is associated with a “binning over date-time” feature can include an NL utterance that references binning operation over another particular date-time interval corresponding to a second date-time extraction function of the set of date-time extraction functions and a LF that corresponds to the NL utterance and includes the second date-time extraction function. Examples of date-time extraction functions included in the set of date-time extraction functions along with their respective date-time intervals, logical names, and example outputs are shown in Table 5.

TABLE 5

| Date-Time Interval Name | Logical Name | Example Output |
|---|---|---|
| Year | ExtractYear(datetime_column) | 2013, 2014 |
| Quarter | ExtractQuarter(datetime_column) | Q1 2013, Q2 2013, Q3 |
| | | 2013, Q4, 2013, Q1 |
| | | 2014, Q2 2014 |
| Quarter of Year | ExtractQuarterOfYear(datetime_column) | Q1, Q2, Q3, Q4 |
| Month | ExtractMonth(datetime_column) | January 2013, February |
| | | 2013, March 2013 |
| Month of Year | ExtractMonthOfYear(datetime_column) | January, February, |
| | | March, . . . , December |
| Week | ExtractWeek(datetime_column) | Week 01 2013, Week 02 |
| | | 2013, Week 03 2013 |
| Week of Year | ExtractWeekOfYear(datetime_column) | Week 01, Week 02, |
| | | Week 03, . . . , Week 53 |
| Day of Week/Weekday | ExtractDayOfWeek(datetime_column) | Sunday, Monday, |
| | | Tuesday |
| Day | ExtractDay(datetime_column) | 1 Jan. 2013, 1 Feb. 2013, |
| | | 1 Mar. 2013 |
| Day of Year | ExtractDayOfYear(datetime_column) | 1, 2, 3, . . . , 365 |
| Day of Month | ExtractDayOfMonth(datetime_column) | 1, 2, 3, . . . , 31 |
| Hour | ExtractHour(datetime_column) | 1 Jan. 2013 12 AM, |
| | | 1 Jan. 2013 01 AM, |
| | | 1 Jan. 2013 03 AM |
| Hour of Day | ExtractHourOfDay(datetime_column) | 12 AM, 1 AM, 2 |
| | | AM, . . . , 11 PM |
| Minute | ExtractMinute(datetime_column) | 1 Jan. 2013 12:37 AM, |
| | | 1 Jan. 2013 01:46 AM, |
| | | 1 Jan. 2013 03:14 AM |
| Second | ExtractSecond(datetime_column) | 1 Jan. 2013 12:37:14 |
| | | AM, 1 Jan. 2013 |
| | | 01:46:47 AM, |
| | | 1 Jan. 2013 03:14:05 AM |
| Millisecond | ExtractMillisecond(datetime_column) | 1 Jan. 2013 |
| | | 12:37:14.645 AM, |
| | | 1 Jan. 2013 |
| | | 01:46:47.544 AM, |
| | | 1 Jan. 2013 |
| | | 03:14:05.068 AM |

The training examples included in the training data 614 can be obtained from one or more pre-existing datasets (e.g., Spider, SParC, CoSQL datasets and/or others) and/or accessed from one or more sources such as a database, a computing system, a customer or client device, and the like. In some instances, the training examples included in the training data 614 can be obtained from and/or generated by humans (e.g., crowd-sourced human annotators). In other instances, the training examples included in the training data 614 can be automatically generated and/or retrieved from libraries. The NL utterances of the training examples of the training data 614 can include text or input features associated with text such as tokens.

Database schema defines how data is organized within a database such as a relational database. A relational database can be formed of one or more tables with each table of the one or more tables including one or more columns with each column of the one or more columns of a respective table of the one or more tables including one or more values. Each column of the one or more columns of a respective table of the one or more tables represents an attribute of the respective table or database. Each table and column of a relational database can be associated with a unique identifier (e.g., an attribute ID), which can include one or more words (e.g., “order_date”). In some instances, the unique identifier for a respective column of a respective table or the database can be indicative of an attribute represented by the respective column (e.g., the unique identifier “ship date” can indicate that the respective column represents a date-time attribute of the respective table or database). In some instances, the database schema information can include metadata that identifies a type and a natural language name for each column/attribute of the database (e.g., the “order_date” attribute being a date-time attribute with the natural language name “order_date”). For example, the metadata can identify columns corresponding to date-time attributes as date-type columns. In some instances, one or more columns of the relational database may serve as a primary key in which each of the values of the one or more columns that serve as the primary key are unique from each other. In some instances, one or more columns of the relational database may serve as a foreign key which serves to the link the table which includes the one or more columns with another table in the relational database. In some instances, the database schema information for a database includes one or more data structures for storing the unique identifiers of the one or more tables and/or the unique identifiers of the one or more columns. The unique identifiers can be stored by the training data preparer 604 in one or more vectors and/or matrices. In some embodiments, a data structure storing schema information for a relational database can store a directed graph representing the unique identifiers and values.

The splitting of the training data 614 into training and validation sets 614A-614N may be performed randomly (e.g., a 90/10% or 70/30%) or the splitting may be performed in accordance with a more complex validation technique such as K-Fold Cross-Validation, Leave-one-out Cross-Validation, Leave-one-group-out Cross-Validation, Nested Cross-Validation, or the like to minimize sampling bias and overfitting. Before or after splitting, basic NL pre-processing may be performed on the training data 614 by the training data preparer 604. In some instances, the pre-processing includes tokenizing the NL utterances of the training data 614. Tokenizing is splitting a phrase, sentence, paragraph, or an entire text document into smaller units, such as individual words or terms. Each of these smaller units are called tokens. In some instances, the tokens for data assets 614 may then be embedded to word embeddings (e.g., contextualized word embeddings). A word embedding is a learned representation for text where words that have the same meaning have a similar representation. Word embeddings are generated by embedding techniques where individual words are represented as real-valued vectors in a predefined vector space so they can be understood by deep learning algorithms. The embedding techniques can be joint or individual embedding techniques such as including an embedding layer within the deep learning algorithm or using a separate model such as a BERT-based pretrained language model (e.g., BERT, ROBERTa, and DeBERTa). BERT-based models are pretrained language models that use self-supervised learning to learn the deep meaning of words and contexts.

The training data augmenter 616 generates augmented training data 636, which is used by the model trainer 608 to train the models 610. The training data augmenter 616 generates the augmented training data 636 by selecting training examples in the training data 614 for augmentation, performing augmentation on the selected training examples to generate augmented training examples, and combining the augmented training examples with the training examples in the training data to generate the augmented training data 636. As described above, the augmented training data 636 can be used to train the model 612 (e.g., a C20MRL model). In some implementations, the training examples can be selected as part of the augmentation process and/or prior to the augmentation process.

The training data augmenter 616 selects training examples in the training data 614 for augmentation by identifying training examples in the training data 614 that are associated with a “binning over date-time” feature and selecting those training examples for augmentation. As described above, a training example that is associated with a “binning over date-time” feature includes tuples of an NL utterance that references a binning operation over a particular date-time interval, a LF that corresponds to the NL utterance and includes a date-time extraction function that corresponds to the particular date-time interval, and database schema information corresponding to the NL utterance and the LF. The training data augmenter 616 can identify whether a respective training example in the training data 614 is associated with a “binning over date-time” feature based on whether a date-time interval label is associated with the respective training example. As described above, each NL utterance that references a binning operation over a particular date-time interval can be labeled with a date-time interval label that identifies the word or sequence of words that correspond to the particular date-time interval referenced by that NL utterance and the particular date-time interval that is referenced (e.g., sequence of words “month of the year” and label “Month Of Year”). In the event a date-time interval label is associated with the respective training example (e.g., the NL utterance of the respective training label is associated with a date-time interval label), the training data augmenter 616 can select the respective training example for augmentation. In the event a date-time interval label is not associated with the respective training example (e.g., the NL utterance of the respective training label is not associated with a date-time interval label), the training data augmenter 616 may not select the respective training example for augmentation. An example of a selected training example is shown in Table 6.

TABLE 6
Selected Training Example

| | | Date-Time |
|---|---|---|
| NL Utterance | LF | Interval |
| Show max profit by | SELECT MAX(profit), | Month Of |
| orders' month | ExtractMonthOfYear(order_date) | |
| of the year | FROM orders GROUP BY | Year |
| | ExtractMonthOfYear(order_date) | |

The training data augmenter 616 performs augmentation on the selected training examples by replacing the date-time extraction functions in the LFs of the selected training examples with new date-time extraction functions and the keywords in the NL utterances of the selected training examples with keywords associated with the new date-time extraction functions. Particularly, for each respective selected training example, the training data augmenter 616 can select a new date-time interval from among the date-time intervals associated with the set of date-time extraction functions, replace the date-time extraction function in the LF with the date-time extraction function corresponding to the new date-time interval, and replace the keyword in the NL utterance with the keyword (i.e., date-time interval name) of the new date-time interval. As described above, each particular date-time interval corresponds to a different date-time extraction function of the set of date-time extraction functions. As such, for each respective selected training example, the training data augmenter 616 can select a date-time interval that is different than the date-time interval that is associated with the respective training example and replace the extraction function in the LF and keyword in the NL utterance according to the selected date-time interval. An example of an augmented training example is shown in Table 7, which in the “month of year” date-time interval and corresponding date-time extraction function “ExtractMonthOfYear” is replaced with the “quarter” date-time interval and its corresponding date-time extraction function “ExtractQuarter”.

TABLE 7
Augmented Training Example

| Selected | | | |
|---|---|---|---|
| Date-Time | | | |
| Extraction | | | Augmented NL |
| Function | Augmented LF | Keyword | Utterance |
| ExtractQuarter | SELECT MAX(profit), | Quarter | Show max |
| | ExtractQuarter(order_date) | | profit by |
| | FROM orders GROUP BY | | order's |
| | ExtractQuarter(order_date) | | quarter |

As discussed above, each respective selected training example can be augmented to generate a respective augmented training example, which can be combined with the training examples in the training data 614 to form the augmented training data 636, which can then be used by the model trainer 608 to train the models 610. In this way, a larger volume of training data can be generated with diversified “binning over date-time” features and used to by the model trainer 608 to train the models 610.

The model trainer 608 trains the model 610 by performing a hyperparameter tuning process that selects hyperparameters for configuring the model 610 and a training process that selects model parameters (e.g., weights and/or biases) for the model 610. Hyperparameters are settings that can be tuned or optimized to control the behavior of the model 610. Most models explicitly define hyperparameters that control different aspects of the models such as memory or cost of execution. However, additional hyperparameters may be defined to adapt a model to a specific scenario. For example, additional hyperparameters may be defined to determine rates for adaptively augmenting the training data, the number of hidden units or layers of a model, the learning rate of a model, the convolution kernel width, and/or the number of parameters for a model.

The hyperparameter tuning process works by identifying N sets of hyperparameters (e.g., via a hyperparameter search technique such as grid search, Bayesian optimization, and the like) and configuring N instances of the model with the N sets of hyperparameters with each instance of the model being configured with a set of hyperparameters of the N sets of hyperparameters. The hyperparameter tuning process performs the hyperparameter tuning by generating logical form predictions for training examples in one or more test sets extracted from the training data 614 with each instance of the model 610 and evaluating performance of each instance of the model by comparing the logical form predictions generated by a respective instance to ground truth logical forms in the respective test set used to train the respective instance of the model (e.g., k-fold cross validation). The hyperparameter tuning process continues by determining the set of hyperparameters of the N sets of hyperparameters that resulted the best performing instance of the model of all the instances of the model (i.e., which model among the instances of the model predicted the labels of the training data for the respective instance with the greatest accuracy) and configuring the model with the determined set of hyperparameters. Accuracy of the model can be represented as a common numeric metric which can maximized or minimized according to the preferences of the user. Searching for a set of hyperparameters to maximize or minimize the metric can be tedious, thus search algorithms like grid search and random search may be used. Grid search picks out a grid of hyperparameter values and evaluates all of them. Guesswork is necessary to specify the min and max values for each hyperparameter. Random search randomly values a random sample of points on the grid. Smart hyperparameter tuning picks a few hyperparameter settings, evaluates the validation matrices, adjusts the hyperparameters, and re-evaluates the validation matrices. Examples of smart hyper-parameter are Spearmint (hyperparameter optimization using Gaussian processes) and Hyperopt (hyperparameter optimization using Tree-based estimators).

The training process works by performing iterative operations of inputting utterances from the augmented training data 636 into the model 610 to find a set of model parameters (e.g., weights and/or biases) that maximizes or minimizes an objective function (e.g., minimizes a loss function for the model 610). The objective function can be constructed to measure the difference between the logical forms inferred using the model 610 and the ground truth logical forms of the training examples of the training data 614. For example, for a supervised learning-based model, the goal of the training is to learn a function “h( )” (also sometimes referred to as the hypothesis function) that maps the training input space X to the target value space Y, h: X→Y, such that h (x) is a good predictor for the corresponding value of y. Various techniques may be used to learn this hypothesis function. In some techniques, as part of deriving the hypothesis function, the objective function may be defined that measures the difference between the ground truth value for input and the predicted value for that input. As part of training, techniques such as back propagation, random feedback, Direct Feedback Alignment (DFA), Indirect Feedback Alignment (IFA), Hebbian learning, Adam Optimization, and the like are used update the model parameters in such a manner as to minimize or maximize this objective function.

The model 610 is trained is once a set of model parameters are identified during the training. After the model 610 has been trained, the model trainer 608 validates the model 610 using the validation sets. The validation process includes iterative operations of inputting the validation sets into the trained model 610 using a validation technique such as K-Fold Cross-Validation, Leave-one-out Cross-Validation, Leave-one-group-out Cross-Validation, Nested Cross-Validation, or the like to obtain logical form outputs and comparing the logical form outputs to the ground truth logical forms of the training examples. The comparison can be performed using correlation techniques such as Bland-Altman method and the Spearman's rank correlation coefficients and calculating performance metrics such as the error, accuracy, precision, recall, receiver operating characteristic curve (ROC), etc. In some instances, the training and validating processes performed by the model trainer 608 can be repeatedly performed by the model trainer 608 until a predetermined condition is satisfied and a final set of model parameters is determined.

As should be understood, other training/validation mechanisms are contemplated and may be implemented within the model system 600. For example, the model 610 may be trained and model parameters may be tuned on datasets from a subset of obtained or filtered datasets and the datasets from a subset of obtained or filtered datasets may only be used for testing and evaluating performance of the model 610. Moreover, although the training mechanisms described herein focus on training a new model 610, these training mechanisms can also be utilized to fine tune existing models trained from other datasets. For example, in some instances, a model 610 might have been pre-trained using datasets from one or more different modalities or tasks. In those cases, the models 610 can be used for transfer learning and retrained/validated using the training and validating data as described above.

Once the models 610, including the NL2LF model 612, have been trained and validated, the training stage 602 can provide the models 610, including the NL2LF model 612, to the NL2LF translation stage 616, where it can be used in conjunction with the input information 638 and the enriched grammar 622 to execute processes for translating a NL utterance included in the input information 638 to a LF 624. The processes can include accessing a grammar 618 and input information 638, enriching the grammar to generate the enriched grammar 622, providing the input information 638 and the enriched grammar 622 to the NL2LF model 612, and using the NL2LF model 612 to convert the NL utterance included in the input information 638 to the LF 624 based on the enriched grammar 622.

The input information 638 can include an NL utterance and database schema information of a target database (e.g., a database to be searched). The NL utterance can include one or more date-time intervals. In some implementations, each date-time interval can correspond to a particular date-time interval (e.g., month, year, week, hour) and/or range of date-time intervals (e.g., months, years). In some implementations, the NL utterance can pertain to a request to aggregate or bin the results over the particular date-time interval (e.g., month, year, week, hour) and/or a request to filter the results for the particular date-time interval. For example, in the case the natural language utterance involves a request to aggregate (or bin) the results over a particular date-time interval such as a month/year/week/hour, the natural language utterance can include “Show total profit by month . . . ”. In another example, in the case the natural language utterance involves a request for the results to be filtered over a particular date-time interval such as an interval starting at the beginning of one month and ending at the end of the next month, the natural language utterance can include “Show average sales by . . . February”.

The database schema information can be associated with a database that is the target of the NL utterance and/or referenced by the NL utterance. For example, in the case the NL utterance includes a request for information, the database schema information of the input information can be the database schema information for the database that is to be searched to locate the requested information. In another example, in the case the NL utterance includes a result for a visualization, the database schema information of the input information can be the database schema information for the database that is to be searched to extract the information for the visualization. The database schema information can be organized as described above and can include one or more date-time attributes as described above.

The grammar 618 can be a RA grammar that includes a set of RA operators, which can be used by the NL2LF translation stage (e.g., by a decoder of the NL2LF translation stage) to generate a tree structure as a representation of the LF 624. The grammar 618 controls the syntax during the translation to ensure that the generated LF 624 has the proper syntax, which will influence the processing steps later (including execution over existing databases). In some implementations, the grammar 618 is adapted for OMRL, an example of which is shown above in Table 3. The grammar enriching stage 620 is configured to enrich the grammar 618 by adding additional operators to the grammar 618. The additional operators can correspond to the set of date-time extraction functions shown above in Table 5. In this way, the grammar can cover particular date-time intervals over date-time time attributes of the input database schema information. An example of a grammar enriched with operators that correspond to a set of date-time extraction functions is shown in Table 8.

TABLE 8

| | Operator | Input → Output |
|---|---|---|
| 1 | Set Union | R × R → R |
| 2 | Set Intersection | R × R → R |
| 3 | Set Difference | R × R → R |
| 4 | Selection | P × R → R |
| 5 | Cartesian Product | R × R → R |
| 6 | Projection | C′ × R → R |
| 7 | And | P × P → P |
| 8 | Or | P × P → P |
| 9 | Comparison | C × C → P |
| 10 | Constant Union | C′ × C′ → C′ |
| 11 | Order by | C × R → R |
| 12 | Group by | C′ × R → R |
| 13 | Limit | C′ × R → R |
| 14 | In/Not In | C′ × R → P |
| 15 | Like/Not Like | C × C → P |
| 16 | Like Start/Not Like Start | C × C → P |
| 17 | Like End/Not Like End | C × C → P |
| 18 | Aggregation | C → C |
| 19 | Distinct | C → C |
| 20 | Keep | Any → Any |
| 21 | Extract Year | C → C |
| 22 | ExtractQuarter | |
| 23 | ExtractQuarterOfYear | |
| 24 | ExtractMonth | |
| 25 | ExtractMonthOfYear | |
| 26 | ExtractWeek | |
| 27 | ExtractWeekOfYear | |
| 28 | ExtractDayOfWeek | |
| 29 | ExtractDay | |
| 30 | ExtractDayOfYear | |
| 31 | ExtractDayOfMonth | |
| 32 | ExtractHour | |
| 33 | ExtractHourOfDay | |
| 34 | ExtractMinute | |
| 35 | ExtractSecond | |
| 36 | ExtractMillisecond | |

In some implementations, at a high level, NL utterances and database schema information associated with those NL utterances are used as input to the NL2LF model 612 and the LF 624 (e.g., OMRL) is predicted based on cues from the NL utterances and the database schema information. The NL2LF model 612 extracts features and variables from the NL utterances and the database schema information to predict the one or more operators and format for the LF 624. In some implementations, the trained NL2LF model 612 predicts the one or more operator and format using one or more semantic parsing tasks.

To predict the LF 624 from the input information 638, an input string is generated by concatenating the NL utterance and the database schema information of the input information 618. To predict the LF 624 from the augmented input information 618, an input string is generated by concatenating the NL utterance and the augmented database schema information of the augmented input information 618.

Based on the input string, one or more embeddings of the NL utterance and the database schema information and/or augmented database schema information are generated by a first encoder. The input string is provided as input to the first encoder. In some instances, the first encoder is a Pre-trained Language Model (PLM), as described with respect to FIG. 5. The first encoder processes the input string to generate the one or more embeddings of NL utterance and the database schema information and/or augmented database schema information. This may be achieved using a single embedding or multiple embeddings. As described above, an embedding is a learned representation for text where words that have the same meaning have a similar representation and embeddings are generated by embedding techniques where individual words are represented as real-valued vectors in a predefined vector space so they can be understood by deep learning algorithms.

A second encoder encodes relations between elements in the database schema information and/or the augmented database schema information and words in the NL utterance, based on the generated one or more embeddings. The generated one or more embeddings are provided from the first encoder to the second encoder. In some instances, the second encoder is a RAT as described with respect to FIG. 5. The second encoder includes multiple self-attention layers configured to apply self-attention to the one or more embeddings to identify relations between the entities in the database schema information and words in the natural language utterance.

In some instances, schema-linking relations that link elements in the database schema information and/or augmented database schema information and words in the NL utterance are also provided to the second encoder, and the embeddings are further generated based on the schema-linking relations. The schema-linking relations provide information to help the second encoder identify how the elements in the database schema information and/or augmented database schema information relate to the words in the NL utterance. Schema linking serves to capture latent linking between tokens in utterances and schema (e.g., entities/attributes in OMRL or tables/columns in SQL). The schema linking relations are encoded into layers of the second encoder as prior knowledge.

In some instances, name-based schema linking (NBSL) is applied. NBSL works to produce matching between tokens in the natural language utterance and elements in the database schema information and/or augmented database schema information. NBSL matches entities such as table names and column names to words in the input utterance, which can be based on an exact match or a partial match for both the primary name and its synonyms to elements in the database schema information.

In some instances, the OMRL schema includes rich metadata. This metadata includes information specifying synonyms for different words. For example, car is a synonym for automobile. Using this rich metadata in the OMRL schema, the NBSL can identify elements in the database schema information and/or augmented database schema information based on identifying synonyms as well as identifying an exact match. In other words, the schema-linking relations comprise metadata specifying synonyms for words. In some instances, the OMRL schema includes link attributes.

In some instances, content-based schema linking (CBSL) is applied. In CBSL for OMRL, data assets are preprocessed using preprocessing techniques. The preprocessing techniques combine named entity recognition and scalable searches (e.g., elastic search) to obtain CBSL matches between words or tokens of an NL utterance and system entities and/or values for attributes within a given database schema. The CBSL matches are appended to the utterance using a unique data structure, and then the data structure is input into the NL2LF model. The data structure facilitates encoding and decoding of the input NL utterance into a LF.

A grammar-based decoder generates a LF (e.g., an intermediate database query representation) based on the encoded relations and the one or more embeddings. As described above with respect to FIG. 5, the grammar-based decoder applies a bottom-up generative process using a beam search to generate an OMRL tree that represents the full OMRL LF. The grammar-based decoder obtains one or more raw beam scores generated from one or more beam levels of the grammar-based decoder. The one or more raw beam scores are used to classify the intermediate database query representation as correct or incorrect. In some instances, the grammar-based decoder accesses the enriched grammar 622 and substitutes the RA grammar with the enriched grammar 622. As discussed above, the enriched grammar 622 is used to generate tree structure to represent the logical form query as a tree. The enriched grammar 622 uses configured RA operators to represent the logical form query. The enriched grammar 622 is used to control the syntax of the decoder output to ensure that the generated logical form will have proper syntax, which will influence the processing steps later (including execution over existing databases). Thus, the LF is further based on the RA grammar. In some instances, a specialized RA grammar is adapted for OMRL.

Using the techniques described herein, in the case an input NL utterance includes a date-time interval, the date-time interval can be identified, encoded, and represented in the LF 624. For example, as shown in FIG. 6B, in a case 690, the output LF 624 can include the extraction function “ExtractYear” which corresponds to the “year” date-time interval in the NL utterance and serves to identify that “year” date-time interval in the output LF 624, and, in the case 692, the output LF 624 can include the extraction function “ExtractMonthOfYear” that corresponds to the “month of year” date-time interval in the NL utterance and serves to identify that “month of year” date-time interval in the output LF 624. By identifying, encoding, and representing the date-time interval of the input NL utterance in the LF 624, the post-processing stage 626 can be aware of date-time intervals included in end user requests.

The post-processing stage 626 processes the LF 624 to generate a post-processed LF 628. In some implementations, the post-processed LF 628 is a statement in a particular query language such as SQL or OAC Backend. As such, the post-processing stage 626 can be configured to processes the LF 624 by translating the LF 624 to one or more desired system query languages (e.g., SQL or OAC Backend). The post-processed LF 628 represents the concepts that are present in the LF 624 in a manner that conforms to the requirements of the applicable system query language. The post-processed LF 628 can be provided to the query execution stage 630 where it can be used to execute a query.

As described above, in cases in which the input NL utterance includes filtering over a date-time interval request, the date-time interval mentioned in the NL utterance may be correctly encoded and represented in the LF 624 as a date-time interval, but the type of date-time interval may not be identified in the LF 624. For example, for the NL utterance, “Show average sales by product category in February,” the output LF can be “SELECT AVG (profit), product_category FROM orders GROUP BY order_date BETWEEN Jan. 2, 2023 AND 28-02-2023,” which correctly includes the date-time interval Feb. 2, 2023-Feb. 28, 2023 but does not identify that the date-time interval refers to a month. As such, by not retaining information on the type of date-time interval (e.g., the month of February), downstream tasks such as analytics retrieval may perform poorly (i.e., the generated results may be different from the end users' expectations and/or may be incorrect).

To address this challenge and others, the post-processing stage 626 can be further configured to process the output LF 624 to determine whether a date-time interval(s) is included in the output LF 624, identify a type for the date-time interval(s), and to generate the post-processed LF 628 by modifying the output LF 624 to include an extraction function(s) that corresponds to the date-time interval(s) and serves to identify the date-time interval(s) in the post-processed LF 628. FIG. 6C shows an example of the post-processing stage 626 that is configured to process the output LF 624 to generate the post-processed LF 628 that includes an extraction function that corresponds to the date-time interval in the LF 624 and serves to identify the date-time interval in the post-processed LF 628. For example, as shown in FIG. 6C, the post-processing stage 626 is configured to process the LF 624 to generate the post-processed LF 628 such that the post-processed LF 628 includes the extraction function “ExtractMonth (order_date)” which corresponds to the July 2022 date-time interval in the LF 624 and serves to identify the July 2022 date-time interval in the post-processed LF 628. To generate the post-processed LF 628 that identifies the date-time interval type, the post-processing stage 626 includes a date selector and distributor sub-stage 644, a final date post-processor sub-stage 646, a recursive date post-processor sub-stage 648, and a combined and list date post-processor sub-stage 650. The post-processing stage 626 can be informed by a named entity recognizer 652.

The date selector and distributor sub-stage 644 accepts the LF 624 as an input string and identifies a clause(s) in the LF 624 that includes a date-time attribute of the input database schema information, extracts a sub-string(s) of the LF 624 that corresponds to the clause(s), and categorizes the sub-string(s) as a final date type sub-string or recursive date type sub-string. A clause of the LF 624 can include a date attribute of the input database schema information, a date-time mention, and an operator that operates on the date-time attribute based on the date-time mention and the date selector and distributor sub-stage 644 can extract the date attribute, the date-time mention, and the operator a sub-string of the LF 624. For example, as shown in FIG. 6C, the LF 624 includes the date-time attribute “order_date,” the date mentions “2022” and “july,” and the operator “OCCUR” in association with the date-time attribute “order_date” and each of the date mentions “2022” and “july,” and, as such, the date selector and distributor sub-stage 644 can identify and extract the clauses “order_date OCCUR ‘2022” and “order_date OCCUR ‘july’” from the LF 624 as sub-strings of LF 624. Once the sub-string(s) of the LF 624 is extracted, the date selector and distributor sub-stage 644 can categorize the sub-string(s) as a final date type sub-string or recursive date type sub-string. A final date type sub-string refers to a sub-string in which the date-time mention of the sub-string is a date-time interval that occurs once (e.g., a particular year, the first week in the particular year, a particular date, and the like). A recursive date type sub-string refers to a sub-string in which the date-time mention of the sub-string is a date-time interval that occurs more than once and at a fixed interval (e.g., the month “July” and the day of the week “Monday” and the like). The date selector and distributor sub-stage 644 can provide a final date type sub-string(s) of the LF 624 to the final date post-processor sub-stage 646 and a recursive date type sub-string(s) of the LF 624 to the recursive date post-processor sub-stage 646.

The final date post-processor sub-stage 646 accepts a final date type sub-string of the LF 624 as an input, identifies the duration type of the date-time mention and corresponding duration value (i.e., interval sub-type), selects an extraction function based on the duration type and duration value from the set of extraction functions, and transforms the final date type sub-string into a transformed final date type sub-string that includes the extraction function. To identify the duration type of the date-time mention and corresponding duration value, the final date post-processor sub-stage 646 utilizes the named entity recognizer 652 to detect date-time type entit(ies) in the final date type sub-string of the LF 624 and determine duration type(s) and duration value(s) for the detected date-time type entit(ies). The named entity recognizer 652 is configured to detect date-time type entit(ies) in the final date type sub-string of the LF 624 and return results that include, for each date-time type entity, the date-time mention, the type of date-time mention, a starting point and ending point within the final date type sub-string for the date-time mention if the date-time mention is associated with a duration, a duration type for the date-time mention, and a duration value for the duration type. An example of the named entity recognizer results for a detected date-time type entity returned by the named entity recognizer 652 when used by the final date post-processor sub-stage 646 is shown in Table 9:

TABLE 9

| Final Date Type Sub-String | order_date OCCUR ‘2022’ |
|---|---|
| “DATE_TIME”:[ | “DATE_TIME”:[ |
| 0:{ | 0:{ |
| “value”: the value of the date | “value”: “2022” |
| “subType”: type of the date | “subType”: “INTERVAL” |
| “startDate”:{ | “startDate”:{ |
| “originalString”:”” | “original String”:”” |
| “subType”: “DATE” | “subType”: “DATE” |
| “timeZone”: “UTC” | “timeZone”: “UTC” |
| “entityName”: “DATE_TIME” | “entityName”: “DATE_TIME” |
| “value”: The start date | “value”: “2022-01-01” |
| } | } |
| “endDate”: { | “endDate”:{ |
| “originalString”:”” | “originalString”:”” |
| “subType”: “DATE” | “subType”: “DATE” |
| “timeZone”: “UTC” | “timeZone”: “UTC” |
| “entity Name”: “DATE_TIME” | “entity Name”: “DATE_TIME” |
| “value”: The end date | “value”: “2022-12-31” |
| } | } |
| “duration”:{ | “duration”:{ |
| “subType”: “DURATION” | “subType”: “DURATION” |
| “timeZone”: “UTC” | “timeZone”: “UTC” |
| “entity Name”: “DATE_TIME” | “entity Name”: “DATE_TIME” |
| “value”: Duration of the date | “value”: “1 Year” |
| } | } |
| } | } |
| } | } |

Based on the duration type and the duration value for each detected date-time entity in the results returned by the named entity recognizer 652, the final date post-processor sub-stage 646 selects an extraction function that corresponds to the duration type and value from the set of extraction functions and transforms the final date type sub-string into a transformed final date type sub-string that substitutes the operator with the extraction function. For example, as shown in Table 9 above and FIG. 6C, for the final date type sub-string “order_date OCCUR ‘2022”, the final date post-processor sub-stage 646 selects the extraction function “ExtractYear” based on the named entity recognizer 652 detecting the date-time mention “2022” and that it corresponds to a duration of “1 Year” and replaces the “OCCUR” operator with the “ExtractYear” extraction function to result in the transformed final date type sub-string “ExtractYear (order_date)=2022”. In the case a date-time entity cannot be expressed with a particular duration type and duration value (e.g., between 2013 Jun. 13 and 2013 Jul. 15), the final date post-processor sub-stage 646 can select the extraction function based on a duration value for a first date-time entity in the final date type sub-string and a duration value for a second date-time entity in the final date type sub-string for the date-time mention (e.g., ExtractDay (date) BETWEEN ‘2013 Jun. 13’ and ‘2013 Jul. 15’). The final date post-processor sub-stage 646 can provide the transformed final date type sub-string(s) of the LF 640 to the combined and list date post-processor stage 650.

The recursive date post-processor sub-stage 648 accepts a recursive date type sub-string of the LF 624 as an input, identifies the recurring interval of the date-time mention and corresponding recurring value (i.e., recursive sub-type), selects an extraction function based on the recurring interval from the set of extraction functions, and transforms the recursive date type sub-string into a transformed recursive date type sub-string based on the extraction function. To identify the recurring interval of the date-time mention and corresponding recurring value, the recursive date post-processor sub-stage 648 utilizes the named entity recognizer 652 to detect date-time type entit(ies) in the recursive date type sub-string of the LF 624 and determine a recurring interval(s) and recurring value(s) for the detected date-time type entit(ies). The named entity recognizer 652 is configured to detect date-time type entit(ies) in the recursive date type sub-string of the LF 624 and return results that include, for each date-time type entity, the date-time mention, the type of date-time mention, a starting point and ending point within the recursive date type sub-string for the date-time mention if the date-time mention is associated with a duration, a recurring type for the date-time mention, and a recurring value for the duration type. An example of the named entity recognizer results for a detected date-time type entity returned by the named entity recognizer 652 when used in the recursive date post-processor sub-stage 648 is shown in Table 10:

TABLE 10

```
order_date OCCUR ‘july’
“DATE_TIME”:[
  0:{
    “originalString”: “July”
    “subType”: “RECURSIVE”
    “relativeReference”: “Month”
    “relativeRepresentation”: “Jul”
    “Month”: “07”
    “duration”:{
        “originalString”: “July”,
        “subType”: “DURATION”,
        “timeZone”: “UTC”,
        “entityName”: “DATE_TIME”,
        “value”: “1 Month”
      }
    “entityName”: “DATE_TIME”
    }
}
```

Based on the recurring interval type and the recurring value for each detected date-time entity in the results returned by the named entity recognizer 652, the recursive date post-processor sub-stage 648 selects an extraction function that corresponds to the recurring interval and value from the set of extraction functions and transforms the recursive date type sub-string into a transformed recursive date type sub-string that substitutes the operator with the extraction function. For example, as shown in Table 10 above and FIG. 6C, for the final date type sub-string “order_date OCCUR ‘july’”, the recursive date post-processor sub-stage 648 selects the extraction function “ExtractMonthOfYear” based on the named entity recognizer 652 detecting the date-time mention “july” and that it corresponds to a recurring interval of “1 Month” and replaces the “OCCUR” operator with the “ExtractMonthOfYear” extraction function to result in the transformed recursive date type sub-string “ExtractMonthOfYear (order_date)=07”. The recursive date post-processor sub-stage 648 can provide the transformed recursive date type sub-string(s) of the LF 624 to the combined and list date post-processor stage 650.

The combined and list date post-processor sub-stage 650 accepts a transformed final date type sub-string(s) of the LF 640 provided by the final date type post-processor sub-stage 646 and/or a transformed recursive date type sub-string(s) of the LF 640 provided by the recursive date type post-processor sub-stage 648 and generates the post-processed LF 628 from the transformed final date type sub-string(s) and/or the transformed recursive date type sub-string. In the event that a single transformed sub-string (e.g., a transformed final type sub-string or transformed recursive date type sub-string) is provided to the combined and list date post-processor sub-stage 650, the combined and list date post-processor sub-stage 650 can generate the post-processed LF 628 based on the single transformed sub-string and the extraction function of the single transformed sub-string. For example, for the transformed recursive date type sub-string “ExtractMonthOfYear (order_date)=07”, the combined and list date post-processor sub-stage 650 can generate the post-processed LF 628 such that it includes the “ExtractMonthOfYear” extraction function. In the event that two or more sub-strings (e.g., a transformed final type sub-string and a transformed recursive date type sub-string) are provided to the combined and list date post-processor sub-stage 650, the combined and list date post-processor sub-stage 650 can generate the post-processed LF 628 based on all of the sub-strings by referencing a table of extraction functions for combined date types. An example of the table of extraction functions for combined date types is shown in Table 11. The combined and list date post-processor sub-stage 650 can select a final extraction function for the post-processed LF 628 based on a first extraction function included in a first sub-string of the two or more sub-strings and a second extraction function included in a second sub-string of the two or more sub-strings. For example, as shown in FIG. 6C, the first extraction function can be the “ExtractYear” extraction function of the transformed final type sub-string and the second extraction function can be the “ExtractMonthOfYear” extraction function and based on the table of extraction functions for combined date types, the final extraction function can be the “ExtractMonth” extraction function.

TABLE 11

| First Extraction | Second Extraction | Final Extraction |
|---|---|---|
| Function | Function | Function |
| ExtractYear | ExtractDayOfYear | ExtractDay |
| ExtractYear | ExtractMonthOfYear | ExtractMonth |
| ExtractYear | ExtractQuarterOfYear | ExtractQuarter |
| ExtractYear | ExtractWeekOfYear | ExtractWeek |

In the event that a transformed sub-string(s) (e.g., a transformed final type sub-string and/or recursive date type sub-string(s)) includes a list of dates where each date of the list dates is associated with the same extraction function is provided to the combined and list date post-processor sub-stage 650, the combined and list date post-processor sub-stage 650 can generate the post-processed LF 628 such that it includes the extraction function and the list of dates. For example, given the NL utterance “Display the sales by customer name for office furnishings in 2011, 2012, and 2013” having an output LF “SELECT sales, customer_name FROM orders WHERE product_subcategory=‘office furnishings’ AND order_date OCCUR [2011, 2012, 2013],” the combined list and list date post processor sub-stage 650 can generate the post-processed LF “SELECT sales, customer_name FROM orders WHERE product_subcategory=‘office furnishings’ AND ExtractYear (order_date) IN [2011, 2012, 2013].” In the event that a transformed sub-string(s) (e.g., a transformed final type sub-string and/or recursive date type sub-string(s)) that includes a list of dates having a first extraction function and a date-time interval having a second extraction function is provided to the combined and list date post-processor sub-stage 650, the combined and list date post-processor sub-stage 650 can generate the post-processed LF 628 such that it includes the list of dates and the extraction functions concatenated individually. An example of a table of extraction functions for the list of dates is shown in Table 12.

TABLE 12

| NL Utterance | Extraction Function 1 | Extraction Function 2 | Final Extraction Function |
|---|---|---|---|
| Display the | ExtractMonthofYear(order_date) = | Extract Year(order_date) | ExtractMonth(order_date) |
| July sales | ‘07’ | IN [‘2011’, ‘2012’, | IN [‘2011 July’, ‘2012 July’, |
| by customer | | ‘2013’] | ‘2013 July’] |
| name for office | | | |
| furnishings in | | | |
| 2011, 2012, | | | |
| and 2013 | | | |
| Display the | ExtractMonthofYear(order_date) | Extract Year(order_date) = | ExtractMonth(order_date) |
| April, July, | IN [‘04’, ‘07’, ‘10’] | ‘2011’ | IN [‘2011 April’, 2011 July’, |
| October sales | | | ‘2011 October’] |
| by customer | | | |
| name for office | | | |
| furnishings | | | |
| in 2011 | | | |

In this way, in cases in which the input NL utterance includes filtering over a date-time interval request, the date-time interval mentioned in the NL utterance may be correctly identified, encoded, and represented in the LF 624 as a date-time interval and the type of date-time interval it is.

The query execution stage 630 includes one or more executors that are configured to execute the post-processed LF 628 on a system such as database 632 to obtain a result 634 (e.g., an answer to a query within NL utterances(s)) or OAC to generate a visualization (not shown). For example, the one or more executors may be configured to translate or convert the post-processed LF 628 to a systems language query or command such as SQL, APIs, REST, GraphQL, PGQL, OAC Backend, etc., and execute the systems language query or command on a relational database such as database 632 to obtain the result 634 such as an answer to a query posed in the NL utterance(s). The result 634 can be provided to a user device. In the case of a visualization, the visualization can be provided to a user device. In some implementations, the database 632 can be the database associated with the database schema information of the input information 638 and the result 634 can describe information corresponding to the date-time interval of the natural language utterance of the input information 638. In the case of a visualization, the visualization can include visual information that describes the information corresponding to the date-time interval of the natural language utterance of the input information 638.

While not explicitly shown, it will be appreciated that the system 600 may further include a developer device associated with a developer. Communications from a developer device to components of the system 600 may indicate what types of input data, utterances, and/or database schema are to be used for the models, a number and type of models to be used, hyperparameters of each model, for example, learning rate and number of hidden layers, how data requests are to be formatted, which training data is to be used (e.g., and how to gain access to the training data) and which validation technique is to be used, and/or how the controller processes are to be configured.

FIG. 6D is a diagram of a computing workflow for converting a natural language utterance into a query language output statement that is executed on a database. As shown in FIG. 6D, in a text based use case such as SQL Dialogs skill on the Oracle Digital Assistant (ODA) platform, the OMRL is converted into SQL and executed against a database. A first subsystem 660 of the computing architecture (e.g., C20MRL) employs a machine-learning stack of multiple deep learning-based models 666 for transforming a NL utterance 664 into a logical form 670. An example of the first subsystem 605 is described above with respect to FIGS. 4-6C. The logical form 668 (e.g., OMRL) is an intermediate representation. Using a second subsystem 662 (e.g., SQL backend and Oracle DB), the logical form 668 is mapped to one or more backend programming languages 670 such as SQL (e.g., OMRL2SQL backend). The one or more backend programming languages 670 are then executed, by an execution engine 674, against one or more systems (or components of systems such as a database 672 from Oracle DB) to retrieve a result 676 such as a text output. The text output can be used by the ODA platform to formulate a reply to the utterance 664.

FIG. 6E is a diagram of a computing workflow for converting a natural language utterance into a query language output statement to generate a visualization. As shown in FIG. 6E, in a visualization based use case such as chart/visualization supported by the OAC platform, the OMRL would be converted into OAC API and executed against the OAC. Similar to the computing architecture shown in FIG. 6D, a first subsystem 660 employs a machine-learning stack of multiple deep learning-based models 666 for transforming a NL utterance 664 into a logical form 668. In this instance however, the utterance 668 can be recognized as a request for a visualization output (e.g., a chart, figure, table, graph, etc.). The request may be referred to as a visualization query. The logical form 668 (e.g., OMRL) is an intermediate representation. Using a second subsystem 662 (e.g., OAC Backend), the logical form 668 is mapped to one or more backend programming languages 670 such as OAC (e.g., OMRL20AC backend). The one or more backend programming languages 670 are then be executed, by an Application Programming Interface 678 (OAC API), against one or more systems (or components of systems such as an analytics program from OAC) to retrieve a result 680 such as a visualization. The visualization can be used by the ODA platform to formulate a reply to the utterance 664. In some instances, the user can make additional statements that cause the first subsystem 660 and second subsystem 662 to modify the visualization output.

### Illustrative Methods

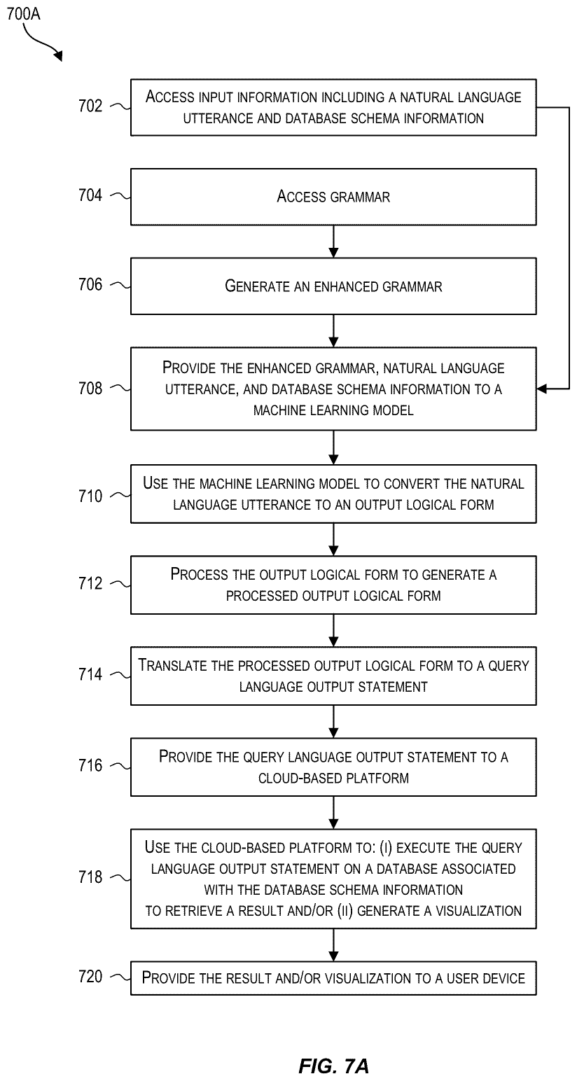

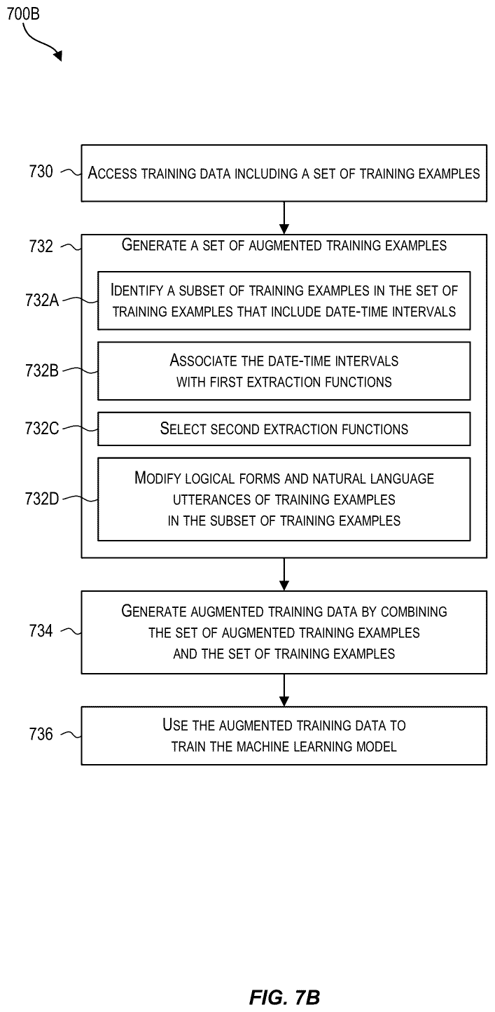

FIG. 7A is a process flow 700A for using a machine learning model to transform a natural language utterance to a logical form. The process flow depicted in FIG. 7A may be implemented in software (e.g., code, instructions, program) executed by one or more processing units (e.g., processors, cores) of the respective systems, hardware, or combinations thereof. The software may be stored on one or more non-transitory storage media (e.g., on a memory device). The process flow presented in FIG. 7A and described below is intended to be illustrative and non-limiting. Although FIG. 7A depicts the various steps occurring in a particular sequence or order, this is not intended to be limiting. In certain alternative embodiments, the steps may be performed in some different order or some steps may also be performed in parallel. In certain embodiments, such as in the embodiment depicted in FIGS. 1-6E, the process flow depicted in FIG. 7A may be performed by a system (e.g., system 600) and/or a subsystem of a system (e.g., first subsystem 660 and/or second subsystem 662).

At block 702, input information is accessed. In some implementations, the input information includes a natural language utterance and database schema information. In some implementations, the natural language utterance includes one or more date-time intervals. In some implementations, each date-time interval can correspond to a particular date-time interval (e.g., month, year, week, hour) and/or range of date-time intervals (e.g., months, years). In some implementations, the natural language utterance can pertain to a request to aggregate or bin the results over the particular date-time interval (e.g., month, year, week, hour) and/or a request to filter the results for the particular date-time interval. For example, in the case the natural language utterance involves a request to aggregate (or bin) the results over a particular date-time interval such as a month/year/week/hour, the natural language utterance can include “Show total profit by month . . . ”. In another example, in the case the natural language utterance involves a request for the results to be filtered over a particular date-time interval such as an interval starting at the beginning of one month and ending at the end of the next month, the natural language utterance can include “Show average sales by . . . February”.

The database schema information can be associated with a database that is the target of the natural language utterance and/or referenced by the natural language utterance. For example, in the case the natural language utterance includes a request for information, the database schema information of the input information can be the database schema information for the database that is to be searched to locate the requested information. In another example, in the case the natural language utterance includes a result for a visualization, the database schema information of the input information can be the database schema information for the database that is to be searched to extract the information for the visualization. The database schema information can be organized as described above and can include one or more date-time attributes as described above.

At block 704, a grammar can be accessed. In some implementations, the grammar can be a relational algebra grammar that includes a set of relational algebra operators. In some implementations, the grammar is adapted for OMRL as shown above in Table 3.

At block 706, an enhanced grammar is generated. In some implementations, the enhanced grammar is generated by adding a set of date-time extraction functions to the grammar. As such, the enhanced grammar includes a set of relational algebra operators and a set of date-time extraction functions. The set of date-time extraction functions can correspond to the set of date-time extraction functions shown above in Table 5. In this way, the grammar can cover particular date-time intervals over date-time time attributes of the input database schema information. An example of a grammar enriched with operators that correspond to a set of date-time extraction functions is shown above in Table 8.

At block 708, the enhanced grammar, the natural language utterance, and database schema information is provided to a machine learning model that has been trained to convert natural language utterances to logical forms. The process flow by which the machine learning model is trained to convert natural language utterances to logical forms will be described later with respect to FIG. 7C.

At block 710, the machine learning model is used to convert the natural language utterance to an output logical form. In some implementations, the output logical form includes the date-time interval and/or an extraction function for extracting date-time information corresponding to the date-time interval from at least one date-time attribute of the database schema information of the input information. In some implementations, in the case the output logical form includes the extraction function, the machine learning model can convert the natural language utterance to the output logical form based at least in-part on selecting the extracting function from the set of date-time extraction functions. Techniques for predicting a logical form from input information including a natural language utterance and a database schema information are described above with respect to FIGS. 6A-6E.

At block 712, the output logical form is processed to generate a processed output logical form. In some implementations, the processing output logical form to generate the processed output logical form includes identifying a portion of the output logical form that includes a logical form operator and the date-time interval and replacing the portion with a replacement extraction function selected from a set of extraction functions that are configured to extract date-information from date-time attributes included in a database schema. In some implementations, the processing the output logical form to generate the processed output logical form further includes using a named entity recognizer to identify a type for the date-time interval and selecting the replacement extraction function based on the type for the date-time interval.

In some implementations, the processed output logical form is a statement in a particular query language such as SQL or OAC Backend. As such, the output logical form can be processed by translating the output logical form to one or more desired system query languages (e.g., SQL or OAC Backend). The processed output logical form represents the concepts that are present in the output logical form in a manner that conforms to the requirements of the applicable system query language.

In some implementations, processing the output logical form includes determining whether a date-time interval(s) is included in the output logical form and identifying a type for the date-time interval(s). The processed output logical form is generated by modifying the output logical form to include an extraction function(s) that corresponds to the date-time interval(s) and serves to identify the date-time interval(s) in the processed output logical form. For example, the processed output logical form is generated such that the processed output logical form includes the extraction function “ExtractMonth (order_date)” which corresponds to the July 2022 date-time interval in the output logical form and serves to identify the July 2022 date-time interval in the processed output logical form. In some implementations, the output logical form can be processed according to the techniques described above with respect to FIG. 6C. In this way, in cases in which the input natural language utterance includes filtering over a date-time interval request, the date-time interval mentioned in the natural language utterance may be correctly identified, encoded, and represented in the output logical form as a date-time interval and the type of date-time interval it is.

At block 714, the processed output logical form can be translated into a query language output statement. In some implementations, the processed output logical form can be translated into a systems language query or command such as SQL, APIs, REST, GraphQL, PGQL, OAC Backend, etc.

At block 716, the query language output statement is provided to a cloud-based platform. Examples of cloud-based platforms are described above with respect to FIGS. 6D and 6E.

At block 718, the cloud-based platform is used to: (i) execute the query language output statement on a database associated with the database schema information to retrieve a result and/or (ii) generate a visualization. In some implementations, the result can describe information corresponding to the date-time interval of the natural language utterance. In some implementations, the visualization includes visual information describing information corresponding to the date-time interval of the natural language utterance.

At block 720, the result and/or the visualization can be provided a user device. In some implementations, providing the result and/or the visualization to the user device includes incorporating the result for the query and/or the visualization in a dialog between the user device and a skill bot and presenting the dialog on a display of the user device.

FIG. 7B is a process flow 700B for training and providing a machine learning model for transforming a natural language utterance to a logical form. The process flow depicted in FIG. 7B may be implemented in software (e.g., code, instructions, program) executed by one or more processing units (e.g., processors, cores) of the respective systems, hardware, or combinations thereof. The software may be stored on one or more non-transitory storage media (e.g., on a memory device). The process flow presented in FIG. 7B and described below is intended to be illustrative and non-limiting. Although FIG. 7B depicts the various steps occurring in a particular sequence or order, this is not intended to be limiting. In certain alternative embodiments, the steps may be performed in some different order or some steps may also be performed in parallel. In certain embodiments, such as in the embodiment depicted in FIGS. 1-6E, the process flow depicted in FIG. 7B may be performed by a system (e.g., system 600) and/or a subsystem of a system (e.g., first subsystem 660 and/or second subsystem 662).

At block 730, training data is accessed. The training data can include the set of training examples. One or more training examples of the training data includes tuples of a natural language utterance, a logical form corresponding to the natural language utterance (e.g., a natural language utterance and an OMRL representation of the natural language utterance), and database schema information corresponding to the natural language utterance and the logical form. In some implementations, one or more training examples of the training data can be associated with a “binning over date-time” feature. A training example that is associated with a “binning over date-time” feature includes tuples of a natural language utterance that references a binning operation over a particular date-time interval, a logical form that corresponds to the natural language utterance and includes a date-time extraction function pertaining to the particular date-time interval, and database schema information corresponding to the natural language utterance and the logical form. The logical form of a respective training example including a training example that is associated with a “binning over date-time feature” can serve as ground truth information for that respective training example. Additionally, the database schema information of a respective training example including a training example that is associated with a “binning over date-time feature” can correspond to an example database that can be queried using the natural language utterance and logical form of the respective training example. An example of a training example that is associated with a “binning over date-time” feature as shown in Table 4 above.

Examples of date-time intervals include year, quarter, quarter of year, month, month of year, week, week of year, day of week (weekday), day, day of year, day of month, hour, hour of day, minute, second, millisecond, and others. As described above, a training example that is associated with a “binning over date-time” feature includes a natural language utterance that references a binning operation over a particular date-time interval and a logical form that corresponds to the natural language utterance and includes a date-time extraction function pertaining to the particular date-time interval. A natural language utterance that references a binning operation over a particular date-time interval includes a word or sequence of words (i.e., a keyword) that correspond to the particular date-time interval referenced by the natural language utterance. For example, as shown in Table 4 above, for a training example that includes the natural language utterance “show maximum profit by orders' month of the year,” the sequence of words “month of the year” corresponds to the date-time interval “month of year.” As such, the natural language utterance shown in Table 4 is a natural language utterance of a training example that is associated with a “binning over date-time” feature. Each natural language utterance that references a binning operation over a particular date-time interval can be labeled with a date-time interval label that identifies the word or sequence of words that correspond to the particular date-time interval referenced by that natural language utterance and the particular date-time interval that is referenced (e.g., sequence of words “month of the year” and label “Month Of Year”). A logical form that corresponds to a natural language utterance that references binning operation over a particular date-time interval includes a date-time extraction function that corresponds to that particular date-time interval. The date-time extraction function corresponding to a particular date-time interval can be configured to extract information (e.g., from a database to be searched) covering that particular date-time interval. For example, as shown in Table 4 above, for a training example that includes the OMRL Logical Form “SELECT MAX (Profit), ExtractMonthOfYear (Order_Date) FROM Orders GROUP BY ExtractMonthOfYear (Order_Date),” the “ExtractMonthOfYear” date-time extraction function, which is configured to extract information from the “Order Date” attribute of an “Orders” table in a database, corresponds to the “month of the year” date-time interval of its corresponding natural language utterance. Each logical form that includes a date-time extraction function can be labeled with a label that identifies the name of the date-time extraction function (e.g., “ExtractMonthOfYear” and label “Month of Year”).

The date-time extraction function can belong to a set of date-time extraction functions. At least one training example can be provided for each date-time extraction function of the set of date-time extraction functions. For example, a first training example that is associated with a “binning over date-time” feature can include a natural language utterance that references a binning operation over a particular date-time interval corresponding to a first date-time extraction function of the set of date-time extraction functions and a logical form that corresponds to the natural language utterance and includes the first date-time extraction function. In another example, a second training example that is associated with a “binning over date-time” feature can include a natural language utterance that references binning operation over another particular date-time interval corresponding to a second date-time extraction function of the set of date-time extraction functions and a logical form that corresponds to the natural language utterance and includes the second date-time extraction function. Examples of date-time extraction functions included in the set of date-time extraction functions along with their respective date-time intervals, logical names, and example outputs are shown in Table 5 above.

In some implementations, the training data can be accessed from one or more sources such as a database, a computing system, a customer or client, and the like. In some implementations, the training data can be the training data 614 described above with respect to FIG. 6A.

At block 732, a set of augmented training examples is generated. The set of augmented training examples can be generated from training examples in the set of training examples. In some implementations, the set of augmented training examples can be generated from training examples in the set of training examples by: at block 732A, identifying a subset of training examples in the set of training examples that include date-time intervals; at block 732B, associating the date-time intervals with first extraction functions included in a set of extraction functions that are configured to extract date-time information from date-time attributes included in a database schema; at block 732C, selecting second extraction functions included in the set of extraction functions that are different from the first extraction functions; and, at block 732D, modifying logical forms and natural language utterances of training examples in the subset of training examples based on the second extraction functions to result in the set of augmented training examples.

In some implementations, training examples in the training data can be selected for augmentation by identifying training examples in the training data that are associated with a “binning over date-time” feature and selecting those training examples for augmentation. A respective training example in the training data can be determined to be associated with a “binning over date-time” feature based on whether a date-time interval label is associated with the respective training example. In the event a date-time interval label is associated with the respective training example (e.g., the natural language utterance of the respective training label is associated with a date-time interval label), the respective training example can be selected for augmentation. In the event a date-time interval label is not associated with the respective training example (e.g., the natural language utterance of the respective training label is not associated with a date-time interval label), the respective training example may not be selected for augmentation. An example of a selected training example is shown in Table 6 above.

Augmentation can be performed on the selected training examples by replacing the date-time extraction functions in the logical forms of the selected training examples with new date-time extraction functions and the keywords in the natural language utterances of the selected training examples with keywords associated with the new date-time extraction functions. Particularly, for each respective selected training example, a new date-time interval can be selected from among the date-time intervals associated with the set of date-time extraction functions, the date-time extraction function in the logical form can be replaced with the date-time extraction function corresponding to the new date-time interval, and the keyword in the natural language utterance can be replaced with the keyword (i.e., date-time interval name) of the new date-time interval. As such, for each respective selected training example, a date-time interval that is different than the date-time interval that is associated with the respective training example can be selected and the extraction function in the logical form and keyword in the NL utterance can be replaced according to the selected date-time interval. An example of an augmented training example is shown in Table 7 above, which in the “month of year” date-time interval and corresponding date-time extraction function “ExtractMonthOfYear” is replaced with the “quarter” date-time interval and its corresponding date-time extraction function “ExtractQuarter”. In this way, a larger volume of training data can be generated with diversified “binning over date-time” features.

At block 734, augmented training data is generated. In some implementations, the augmented training data is generated by combining the set of augmented training examples and the set of training examples.

At block 736, the augmented training data is used to train the machine learning model to convert natural language utterances to logical forms. Techniques for training a machine learning model are described above with respect to FIG. 6A-6C.

### Examples of Cloud Infrastructure

The term cloud service is generally used to refer to a service that is made available by a cloud service provider (CSP) to users (e.g., cloud service customers) on demand (e.g., via a subscription model) using systems and infrastructure (cloud infrastructure) provided by the CSP. Typically, the servers and systems that make up the CSP's infrastructure are separate from the user's own on-premise servers and systems. Users can thus avail themselves of cloud services provided by the CSP without having to purchase separate hardware and software resources for the services. Cloud services are designed to provide a subscribing user easy, scalable access to applications and computing resources without the user having to invest in procuring the infrastructure that is used for providing the services.

There are several cloud service providers that offer various types of cloud services. As discussed herein, there are various types or models of cloud services including IaaS, software as a service (SaaS), platform as a service (PaaS), and others. A user can subscribe to one or more cloud services provided by a CSP. The user can be any entity such as an individual, an organization, an enterprise, and the like. When a user subscribes to or registers for a service provided by a CSP, a tenancy or an account is created for that user. The user can then, via this account, access the subscribed-to one or more cloud resources associated with the account.

As noted above, IaaS is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

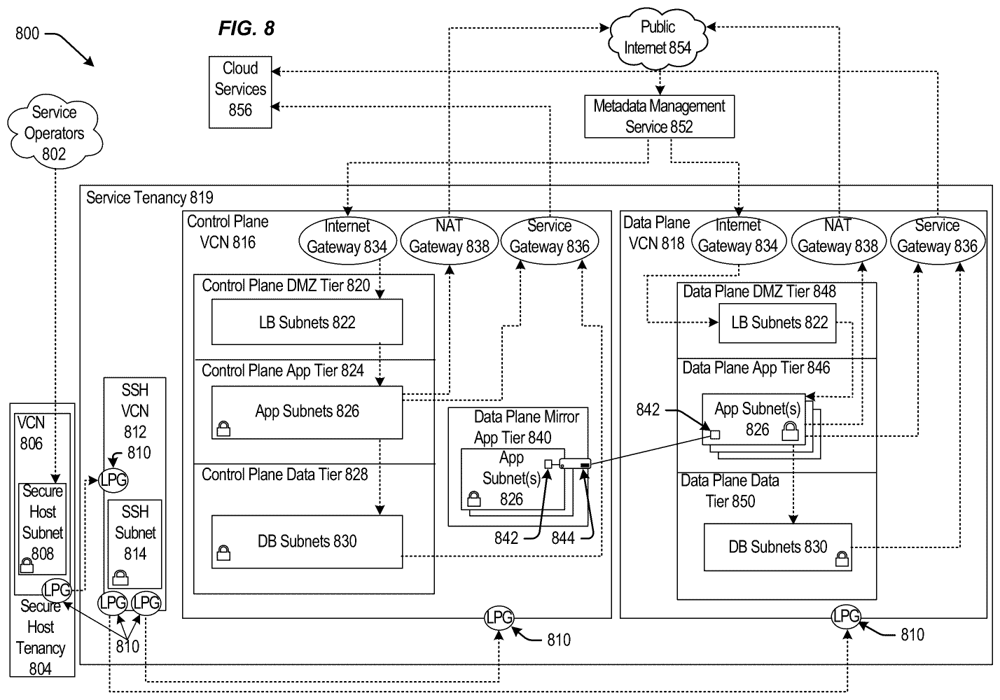

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 contained in the SSH VCN 812. The SSH VCN 812 can include an SSH subnet 814, and the SSH VCN 812 can be communicatively coupled to a control plane VCN 816 via the LPG 810 contained in the control plane VCN 816. Also, the SSH VCN 812 can be communicatively coupled to a data plane VCN 818 via an LPG 810. The control plane VCN 816 and the data plane VCN 818 can be contained in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 contained in the control plane DMZ tier 820 can be communicatively coupled to the app subnet(s) 826 contained in the control plane app tier 824 and an Internet gateway 834 that can be contained in the control plane VCN 816, and the app subnet(s) 826 can be communicatively coupled to the DB subnet(s) 830 contained in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 contained in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be contained in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 can be communicatively coupled to cloud services 856.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way: the service gateway 836 can make API calls to cloud services 856, and cloud services 856 can send requested data to the service gateway 836. But, cloud services 856 may not initiate API calls to the service gateway 836.

In some examples, the secure host tenancy 804 can be directly connected to the service tenancy 819, which may be otherwise isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision desired resources. Desired resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be contained in the data plane mirror app tier 840 and the data plane app tier 846.

In some examples, users of the system, or customers, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 contained in the control plane DMZ tier 820. The LB subnet(s) 822 may determine that the request is valid, and in response to this determination, the LB subnet(s) 822 can transmit the request to app subnet(s) 826 contained in the control plane app tier 824. If the request is validated and requires a call to public Internet 854, the call to public Internet 854 may be transmitted to the NAT gateway 838 that can make the call to public Internet 854. Metadata that may be desired to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to configuration may be desired to be applied to the resources contained in the data plane VCN 818. Via a VNIC 842, the control plane VCN 816 can directly communicate with, and can thereby execute the changes, updates, or other suitable modifications to configuration to, resources contained in the data plane VCN 818.

In some embodiments, the control plane VCN 816 and the data plane VCN 818 can be contained in the service tenancy 819. In this case, the user, or the customer, of the system may not own or operate either the control plane VCN 816 or the data plane VCN 818. Instead, the IaaS provider may own or operate the control plane VCN 816 and the data plane VCN 818, both of which may be contained in the service tenancy 819. This embodiment can enable isolation of networks that may prevent users or customers from interacting with other users', or other customers', resources. Also, this embodiment may allow users or customers of the system to store databases privately without needing to rely on public Internet 854, which may not have a desired level of threat prevention, for storage.

In other embodiments, the LB subnet(s) 822 contained in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may desire this embodiment since database(s) that the customers use may be controlled by the IaaS provider and may be stored on the service tenancy 819, which may be isolated from public Internet 854.

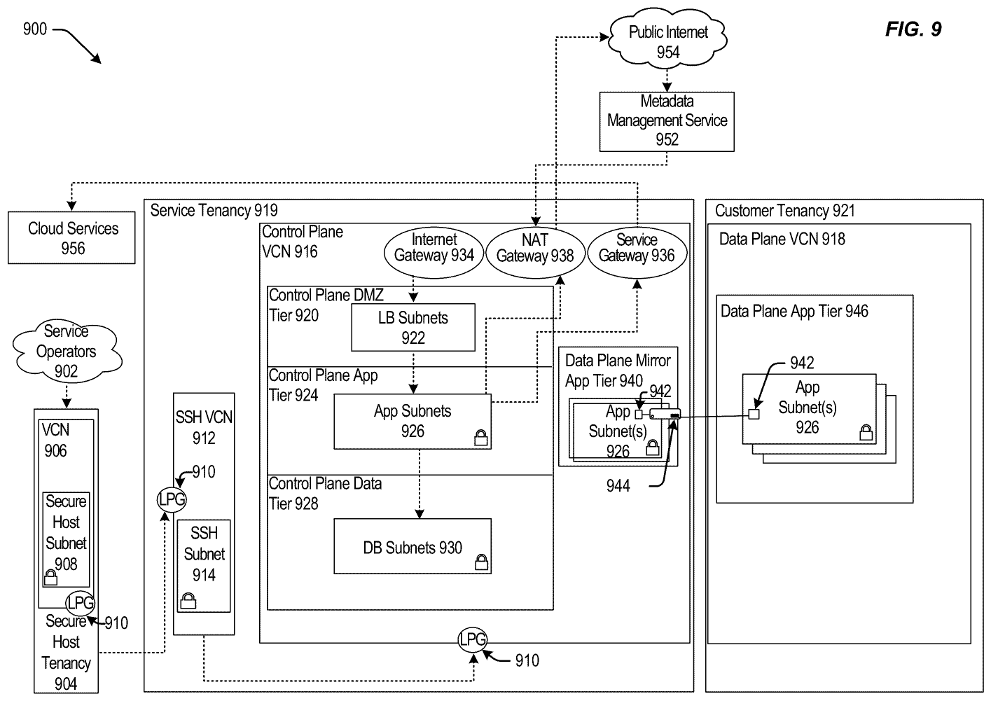

FIG. 9 is a block diagram 900 illustrating another example pattern of an IaaS architecture, according to at least one embodiment. Service operators 902 (e.g., service operators 802 of FIG. 8) can be communicatively coupled to a secure host tenancy 904 (e.g., the secure host tenancy 804 of FIG. 8) that can include a virtual cloud network (VCN) 906 (e.g., the VCN 806 of FIG. 8) and a secure host subnet 908 (e.g., the secure host subnet 808 of FIG. 8). The VCN 806 can include a local peering gateway (LPG) 910 (e.g., the LPG 810 of FIG. 8) that can be communicatively coupled to a secure shell (SSH) VCN 912 (e.g., the SSH VCN 812 of FIG. 8) via an LPG 910 contained in the SSH VCN 912. The SSH VCN 912 can include an SSH subnet 914 (e.g., the SSH subnet 814 of FIG. 8), and the SSH VCN 912 can be communicatively coupled to a control plane VCN 916 (e.g., the control plane VCN 816 of FIG. 8) via an LPG 910 contained in the control plane VCN 916. The control plane VCN 916 can be contained in a service tenancy 919 (e.g., the service tenancy 819 of FIG. 8), and the data plane VCN 918 (e.g., the data plane VCN 818 of FIG. 8) can be contained in a customer tenancy 921 that may be owned or operated by users, or customers, of the system.

The control plane VCN 916 can include a control plane DMZ tier 920 (e.g., the control plane DMZ tier 820 of FIG. 8) that can include LB subnet(s) 922 (e.g., LB subnet(s) 822 of FIG. 8), a control plane app tier 924 (e.g., the control plane app tier 824 of FIG. 8) that can include app subnet(s) 926 (e.g., app subnet(s) 826 of FIG. 8), a control plane data tier 928 (e.g., the control plane data tier 828 of FIG. 8) that can include database (DB) subnet(s) 930 (e.g., similar to DB subnet(s) 830 of FIG. 8). The LB subnet(s) 922 contained in the control plane DMZ tier 920 can be communicatively coupled to the app subnet(s) 926 contained in the control plane app tier 924 and an Internet gateway 934 (e.g., the Internet gateway 834 of FIG. 8) that can be contained in the control plane VCN 916, and the app subnet(s) 926 can be communicatively coupled to the DB subnet(s) 930 contained in the control plane data tier 928 and a service gateway 936 (e.g., the service gateway 836 of FIG. 8) and a network address translation (NAT) gateway 938 (e.g., the NAT gateway 838 of FIG. 8). The control plane VCN 916 can include the service gateway 936 and the NAT gateway 938.

The control plane VCN 916 can include a data plane mirror app tier 940 (e.g., the data plane mirror app tier 840 of FIG. 8) that can include app subnet(s) 926. The app subnet(s) 926 contained in the data plane mirror app tier 940 can include a virtual network interface controller (VNIC) 942 (e.g., the VNIC of 842) that can execute a compute instance 944 (e.g., similar to the compute instance 844 of FIG. 8). The compute instance 944 can facilitate communication between the app subnet(s) 926 of the data plane mirror app tier 940 and the app subnet(s) 926 that can be contained in a data plane app tier 946 (e.g., the data plane app tier 846 of FIG. 8) via the VNIC 942 contained in the data plane mirror app tier 940 and the VNIC 942 contained in the data plane app tier 946.

The Internet gateway 934 contained in the control plane VCN 916 can be communicatively coupled to a metadata management service 952 (e.g., the metadata management service 852 of FIG. 8) that can be communicatively coupled to public Internet 954 (e.g., public Internet 854 of FIG. 8). Public Internet 954 can be communicatively coupled to the NAT gateway 938 contained in the control plane VCN 916. The service gateway 936 contained in the control plane VCN 916 can be communicatively coupled to cloud services 956 (e.g., cloud services 856 of FIG. 8).

In some examples, the data plane VCN 918 can be contained in the customer tenancy 921. In this case, the IaaS provider may provide the control plane VCN 916 for each customer, and the IaaS provider may, for each customer, set up a unique compute instance 944 that is contained in the service tenancy 919. Each compute instance 944 may allow communication between the control plane VCN 916, contained in the service tenancy 919, and the data plane VCN 918 that is contained in the customer tenancy 921. The compute instance 944 may allow resources, that are provisioned in the control plane VCN 916 that is contained in the service tenancy 919, to be deployed or otherwise used in the data plane VCN 918 that is contained in the customer tenancy 921.

In other examples, the customer of the IaaS provider may have databases that live in the customer tenancy 921. In this example, the control plane VCN 916 can include the data plane mirror app tier 940 that can include app subnet(s) 926. The data plane mirror app tier 940 can reside in the data plane VCN 918, but the data plane mirror app tier 940 may not live in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918 but may not be configured to make calls to any entity contained in the control plane VCN 916. The customer may desire to deploy or otherwise use resources in the data plane VCN 918 that are provisioned in the control plane VCN 916, and the data plane mirror app tier 940 can facilitate the desired deployment, or other usage of resources, of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, contained in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be live or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 7,” may be located in Region 1 and in “Region 2.” If a call to Deployment 7 is made by the service gateway 936 contained in the control plane VCN 916 located in Region 1, the call may be transmitted to Deployment 7 in Region 1. In this example, the control plane VCN 916, or Deployment 7 in Region 1, may not be communicatively coupled to, or otherwise in communication with, Deployment 7 in Region 2.

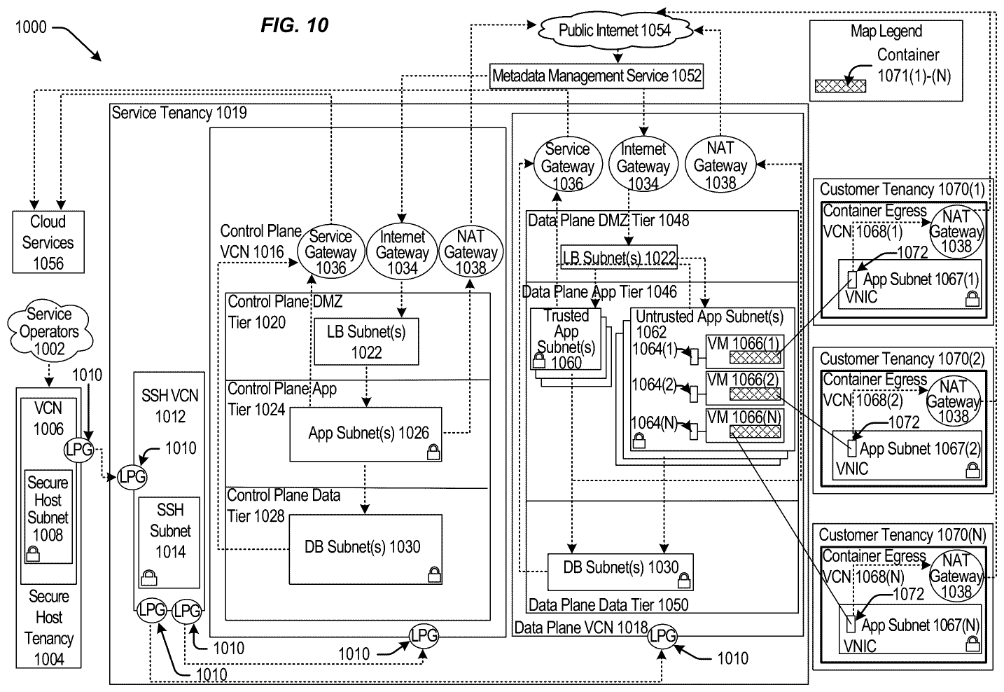

FIG. 10 is a block diagram 1000 illustrating another example pattern of an IaaS architecture, according to at least one embodiment. Service operators 1002 (e.g., service operators 802 of FIG. 8) can be communicatively coupled to a secure host tenancy 1004 (e.g., the secure host tenancy 804 of FIG. 8) that can include a virtual cloud network (VCN) 1006 (e.g., the VCN 806 of FIG. 8) and a secure host subnet 1008 (e.g., the secure host subnet 808 of FIG. 8). The VCN 1006 can include an LPG 1010 (e.g., the LPG 810 of FIG. 8) that can be communicatively coupled to an SSH VCN 1012 (e.g., the SSH VCN 812 of FIG. 8) via an LPG 1010 contained in the SSH VCN 1012. The SSH VCN 1012 can include an SSH subnet 1014 (e.g., the SSH subnet 814 of FIG. 8), and the SSH VCN 1012 can be communicatively coupled to a control plane VCN 1016 (e.g., the control plane VCN 816 of FIG. 8) via an LPG 1010 contained in the control plane VCN 1016 and to a data plane VCN 1018 (e.g., the data plane 818 of FIG. 8) via an LPG 1010 contained in the data plane VCN 1018. The control plane VCN 1016 and the data plane VCN 1018 can be contained in a service tenancy 1019 (e.g., the service tenancy 819 of FIG. 8).

The control plane VCN 1016 can include a control plane DMZ tier 1020 (e.g., the control plane DMZ tier 820 of FIG. 8) that can include load balancer (LB) subnet(s) 1022 (e.g., LB subnet(s) 822 of FIG. 8), a control plane app tier 1024 (e.g., the control plane app tier 824 of FIG. 8) that can include app subnet(s) 1026 (e.g., similar to app subnet(s) 826 of FIG. 8), a control plane data tier 1028 (e.g., the control plane data tier 828 of FIG. 8) that can include DB subnet(s) 1030. The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 834 of FIG. 8) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 8) and a network address translation (NAT) gateway 1038 (e.g., the NAT gateway 838 of FIG. 8). The control plane VCN 1016 can include the service gateway 1036 and the NAT gateway 1038.

The data plane VCN 1018 can include a data plane app tier 1046 (e.g., the data plane app tier 846 of FIG. 8), a data plane DMZ tier 1048 (e.g., the data plane DMZ tier 848 of FIG. 8), and a data plane data tier 1050 (e.g., the data plane data tier 850 of FIG. 8). The data plane DMZ tier 1048 can include LB subnet(s) 1022 that can be communicatively coupled to trusted app subnet(s) 1060 and untrusted app subnet(s) 1062 of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include one or more primary VNICs 1064(1)-(N) that can be communicatively coupled to tenant virtual machines (VMs) 1066(1)-(N). Each tenant VM 1066(1)-(N) can be communicatively coupled to a respective app subnet 1067(1)-(N) that can be contained in respective container egress VCNs 1068(1)-(N) that can be contained in respective customer tenancies 1070(1)-(N). Respective secondary VNICs 1072(1)-(N) can facilitate communication between the untrusted app subnet(s) 1062 contained in the data plane VCN 1018 and the app subnet contained in the container egress VCNs 1068(1)-(N). Each container egress VCNs 1068(1)-(N) can include a NAT gateway 1038 that can be communicatively coupled to public Internet 1054 (e.g., public Internet 854 of FIG. 8).

The Internet gateway 1034 contained in the control plane VCN 1016 and contained in the data plane VCN 1018 can be communicatively coupled to a metadata management service 1052 (e.g., the metadata management system 852 of FIG. 8) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some embodiments, the data plane VCN 1018 can be integrated with customer tenancies 1070. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1046. Code to run the function may be executed in the VMs 1066(1)-(N), and the code may not be configured to run anywhere else on the data plane VCN 1018. Each VM 1066(1)-(N) may be connected to one customer tenancy 1070. Respective containers 1071(1)-(N) contained in the VMs 1066(1)-(N) may be configured to run the code. In this case, there can be a dual isolation (e.g., the containers 1071(1)-(N) running code, where the containers 1071(1)-(N) may be contained in at least the VM 1066(1)-(N) that are contained in the untrusted app subnet(s) 1062), which may help prevent incorrect or otherwise undesirable code from damaging the network of the IaaS provider or from damaging a network of a different customer. The containers 1071(1)-(N) may be communicatively coupled to the customer tenancy 1070 and may be configured to transmit or receive data from the customer tenancy 1070. The containers 1071(1)-(N) may not be configured to transmit or receive data from any other entity in the data plane VCN 1018. Upon completion of running the code, the IaaS provider may kill or otherwise dispose of the containers 1071(1)-(N).

In some embodiments, the trusted app subnet(s) 1060 may run code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)-(N) that can be contained in the VM 1066(1)-(N) of each customer and that may run code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

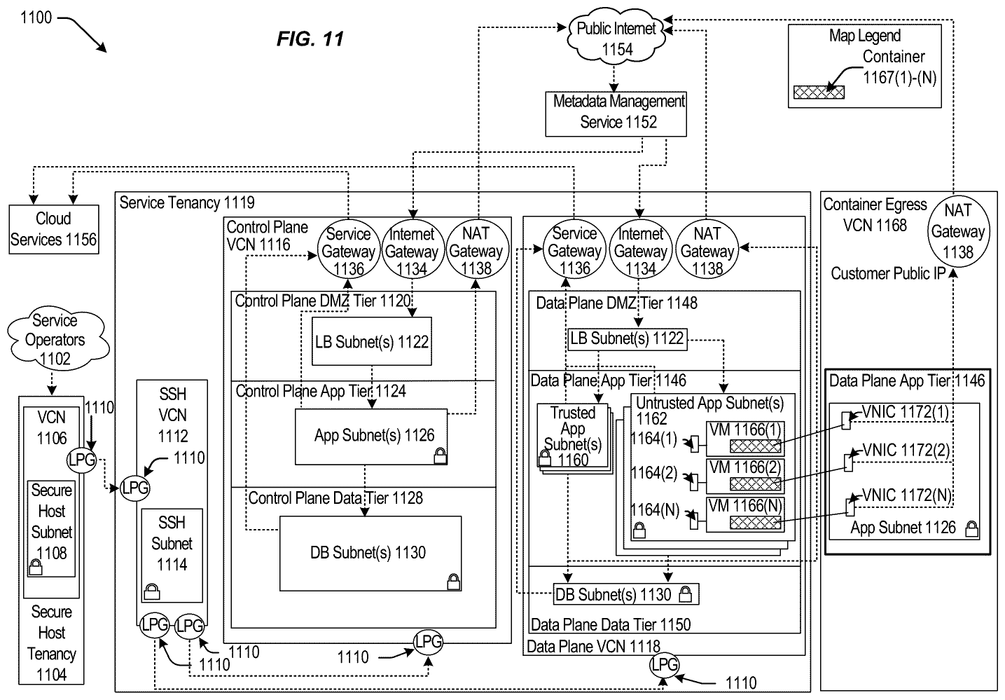

FIG. 11 is a block diagram 1100 illustrating another example pattern of an IaaS architecture, according to at least one embodiment. Service operators 1102 (e.g., service operators 802 of FIG. 8) can be communicatively coupled to a secure host tenancy 1104 (e.g., the secure host tenancy 804 of FIG. 8) that can include a virtual cloud network (VCN) 1106 (e.g., the VCN 806 of FIG. 8) and a secure host subnet 1108 (e.g., the secure host subnet 808 of FIG. 8). The VCN 1106 can include an LPG 1110 (e.g., the LPG 810 of FIG. 8) that can be communicatively coupled to an SSH VCN 1112 (e.g., the SSH VCN 812 of FIG. 8) via an LPG 1110 contained in the SSH VCN 1112. The SSH VCN 1112 can include an SSH subnet 1114 (e.g., the SSH subnet 814 of FIG. 8), and the SSH VCN 1112 can be communicatively coupled to a control plane VCN 1116 (e.g., the control plane VCN 816 of FIG. 8) via an LPG 1110 contained in the control plane VCN 1116 and to a data plane VCN 1118 (e.g., the data plane 818 of FIG. 8) via an LPG 1110 contained in the data plane VCN 1118. The control plane VCN 1116 and the data plane VCN 1118 can be contained in a service tenancy 1119 (e.g., the service tenancy 819 of FIG. 8).

The control plane VCN 1116 can include a control plane DMZ tier 1120 (e.g., the control plane DMZ tier 820 of FIG. 8) that can include LB subnet(s) 1122 (e.g., LB subnet(s) 822 of FIG. 8), a control plane app tier 1124 (e.g., the control plane app tier 824 of FIG. 8) that can include app subnet(s) 1126 (e.g., app subnet(s) 826 of FIG. 8), a control plane data tier 1128 (e.g., the control plane data tier 828 of FIG. 8) that can include DB subnet(s) 1130 (e.g., DB subnet(s) 930 of FIG. 9). The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 834 of FIG. 8) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 8) and a network address translation (NAT) gateway 1138 (e.g., the NAT gateway 838 of FIG. 8). The control plane VCN 1116 can include the service gateway 1136 and the NAT gateway 1138.

The data plane VCN 1118 can include a data plane app tier 1146 (e.g., the data plane app tier 846 of FIG. 8), a data plane DMZ tier 1148 (e.g., the data plane DMZ tier 848 of FIG. 8), and a data plane data tier 1150 (e.g., the data plane data tier 850 of FIG. 8). The data plane DMZ tier 1148 can include LB subnet(s) 1122 that can be communicatively coupled to trusted app subnet(s) 1160 (e.g., trusted app subnet(s) 960 of FIG. 9) and untrusted app subnet(s) 1162 (e.g., untrusted app subnet(s) 962 of FIG. 9) of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include primary VNICs 1164(1)-(N) that can be communicatively coupled to tenant virtual machines (VMs) 1166(1)-(N) residing within the untrusted app subnet(s) 1162. Each tenant VM 1166(1)-(N) can run code in a respective container 1167(1)-(N), and be communicatively coupled to an app subnet 1126 that can be contained in a data plane app tier 1146 that can be contained in a container egress VCN 1168. Respective secondary VNICs 1172(1)-(N) can facilitate communication between the untrusted app subnet(s) 1162 contained in the data plane VCN 1118 and the app subnet contained in the container egress VCN 1168. The container egress VCN can include a NAT gateway 1138 that can be communicatively coupled to public Internet 1154 (e.g., public Internet 854 of FIG. 8).

The Internet gateway 1134 contained in the control plane VCN 1116 and contained in the data plane VCN 1118 can be communicatively coupled to a metadata management service 1152 (e.g., the metadata management system 852 of FIG. 8) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some examples, the pattern illustrated by the architecture of block diagram 1100 of FIG. 11 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1167(1)-(N) that are contained in the VMs 1166(1)-(N) for each customer can be accessed in real-time by the customer. The containers 1167(1)-(N) may be configured to make calls to respective secondary VNICs 1172(1)-(N) contained in app subnet(s) 1126 of the data plane app tier 1146 that can be contained in the container egress VCN 1168. The secondary VNICs 1172(1)-(N) can transmit the calls to the NAT gateway 1138 that may transmit the calls to public Internet 1154. In this example, the containers 1167(1)-(N) that can be accessed in real-time by the customer can be isolated from the control plane VCN 1116 and can be isolated from other entities contained in the data plane VCN 1118. The containers 1167(1)-(N) may also be isolated from resources from other customers.

In other examples, the customer can use the containers 1167(1)-(N) to call cloud services 1156. In this example, the customer may run code in the containers 1167(1)-(N) that requests a service from cloud services 1156. The containers 1167(1)-(N) can transmit this request to the secondary VNICs 1172(1)-(N) that can transmit the request to the NAT gateway that can transmit the request to public Internet 1154. Public Internet 1154 can transmit the request to LB subnet(s) 1122 contained in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 800, 900, 1000, 1100 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

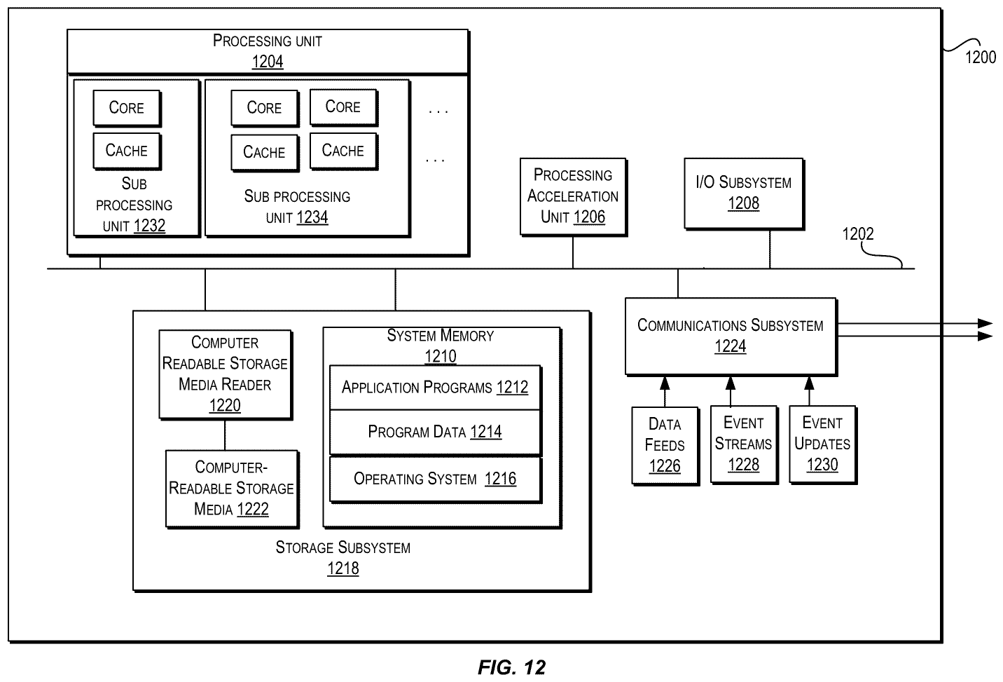

FIG. 12 illustrates an example computer system 1200, in which various embodiments may be implemented. The system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some, or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics, and audio/video information such as monitors, printers, speakers, headphones, automotive navigation systems, plotters, voice output devices, and modems.

Computer system 1200 may comprise a storage subsystem 1218 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1204 provide the functionality described above. Storage subsystem 1218 may also provide a repository for storing data used in accordance with the present disclosure.

As depicted in the example in FIG. 12, storage subsystem 1218 can include various components including a system memory 1210, computer-readable storage media 1222, and a computer readable storage media reader 1220. System memory 1210 may store program instructions that are loadable and executable by processing unit 1204. System memory 1210 may also store data that is used during the execution of the instructions and/or data that is generated during the execution of the program instructions. Various different kinds of programs may be loaded into system memory 1210 including but not limited to client applications, Web browsers, mid-tier applications, relational database management systems (RDBMS), virtual machines, containers, etc.

System memory 1210 may also store an operating system 1216. Examples of operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1200 executes one or more virtual machines, the virtual machines along with their guest operating systems (GOSs) may be loaded into system memory 1210 and executed by one or more processors or cores of processing unit 1204.

System memory 1210 can come in different configurations depending upon the type of computer system 1200. For example, system memory 1210 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1210 may include a basic input/output system (BIOS) containing basic routines that help to transfer information between elements within computer system 1200, such as during start-up.

Computer-readable storage media 1222 may represent remote, local, fixed, and/or removable storage devices plus storage media for temporarily and/or more permanently containing, storing, computer-readable information for use by computer system 1200 including instructions executable by processing unit 1204 of computer system 1200.

Computer-readable storage media 1222 can include any appropriate media known or used in the art, including storage media and communication media, such as but not limited to, volatile and non-volatile, removable, and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1200.

Machine-readable instructions executable by one or more processors or cores of processing unit 1204 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.12 family standards, or other mobile communication technologies, or any combination thereof), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

As used herein, when an action is “based on” something, this means the action is based at least in part on at least a part of the something. As used herein, the terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 5, and 10 percent.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
providing an enhanced grammar, a natural language utterance comprising a date-time interval, and database schema information to a machine learning model that has been trained to convert natural language utterances to logical forms; and
using the machine learning model to convert the natural language utterance to an output logical form, wherein the output logical form comprises at least one of the date-time interval and an extraction function for extracting date-time information corresponding to the date-time interval from at least one date-time attribute of the database schema information.

2. The computer-implemented method of claim 1, wherein the output logical form comprises the extraction function, wherein the enhanced grammar comprises a set of relational algebra operators and a set of date-time extraction functions, and wherein the machine learning model converts the natural language utterance to the output logical form based at least in-part on selecting the extracting function from the set of date-time extraction functions.

3. The computer-implemented method of claim 2, further comprising:
prior to using the machine learning model to convert the natural language utterance to the output logical form:
accessing a grammar comprising the set of relational algebra operators; and
generating the enhanced grammar by adding the set of date-time extraction functions to the grammar.

4. The computer-implemented method of claim 1, wherein the machine learning model has been trained to convert natural language utterances to logical forms by:
accessing training data comprising a set of training examples;
generating a set of augmented training examples from training examples in the set of training examples by:
identifying a subset of training examples in the set of training examples that include date-time intervals;
associating the date-time intervals with first extraction functions included in a set of extraction functions that are configured to extract date-time information from date-time attributes included in a database schema;
selecting second extraction functions included in the set of extraction functions that are different from the first extraction functions; and
modifying logical forms and natural language utterances of training examples in the subset of training examples based on the second extraction functions to result in the set of augmented training examples;
generating augmented training data by combining the set of augmented training examples and the set of training examples; and
using the augmented training data to train the machine learning model to convert natural language utterances to logical forms.

5. The computer-implemented method of claim 1, wherein the output logical form comprises the date-time interval, and the method further comprising:
processing the output logical form to generate a processed output logical form, wherein the processing output logical form to generate the processed output logical form comprises identifying a portion of the output logical form that comprises a logical form operator and the date-time interval and replacing the portion with a replacement extraction function selected from a set of extraction functions that are configured to extract date-information from date-time attributes included in a database schema.

6. The computer-implemented method of claim 5, wherein the processing the output logical form to generate the processed output logical form further comprises using a named entity recognizer to identify a type for the date-time interval and selecting the replacement extraction function based on the type for the date-time interval.

7. The computer-implemented method of claim 5, further comprising:
translating the processed output logical form to a query language output statement;
providing the query language output statement to a cloud-based platform;
using the cloud-based platform to execute the query language output statement on a database associated with the database schema information to retrieve a result describing information corresponding to the date-time interval of the natural language utterance; and
providing the result to a user device.

8. A system comprising:
one or more processors; and
one or more computer-readable media storing instructions which, when executed by the one or more processors, cause the system to perform operations comprising:
providing an enhanced grammar, a natural language utterance comprising a date-time interval, and database schema information to a machine learning model that has been trained to convert natural language utterances to logical forms; and
using the machine learning model to convert the natural language utterance to an output logical form, wherein the output logical form comprises at least one of the date-time interval and an extraction function for extracting date-time information corresponding to the date-time interval from at least one date-time attribute of the database schema information.

9. The system of claim 8, wherein the output logical form comprises the extraction function, wherein the enhanced grammar comprises a set of relational algebra operators and a set of date-time extraction functions, and wherein the machine learning model converts the natural language utterance to the output logical form based at least in-part on selecting the extracting function from the set of date-time extraction functions.

10. The system of claim 9, the operations further comprising:
prior to using the machine learning model to convert the natural language utterance to the output logical form:
accessing a grammar comprising the set of relational algebra operators; and
generating the enhanced grammar by adding the set of date-time extraction functions to the grammar.

11. The system of claim 8, wherein the machine learning model has been trained to convert natural language utterances to logical forms by:
accessing training data comprising a set of training examples;
generating a set of augmented training examples from training examples in the set of training examples by:
identifying a subset of training examples in the set of training examples that include date-time intervals;
associating the date-time intervals with first extraction functions included in a set of extraction functions that are configured to extract date-time information from date-time attributes included in a database schema;
selecting second extraction functions included in the set of extraction functions that are different from the first extraction functions; and
modifying logical forms and natural language utterances of training examples in the subset of training examples based on the second extraction functions to result in the set of augmented training examples;
generating augmented training data by combining the set of augmented training examples and the set of training examples; and
using the augmented training data to train the machine learning model to convert natural language utterances to logical forms.

12. The system of claim 8, wherein the output logical form comprises the date-time interval, and the operations further comprising:
processing the output logical form to generate a processed output logical form, wherein the processing output logical form to generate the processed output logical form comprises identifying a portion of the output logical form that comprises a logical form operator and the date-time interval and replacing the portion with a replacement extraction function selected from a set of extraction functions that are configured to extract date-information from date-time attributes included in a database schema.

13. The system of claim 12, wherein the processing the output logical form to generate the processed output logical form further comprises using a named entity recognizer to identify a type for the date-time interval and selecting the replacement extraction function based on the type for the date-time interval.

14. The system of claim 12, the operations further comprising:
translating the processed output logical form to a query language output statement;
providing the query language output statement to a cloud-based platform;
using the cloud-based platform to generate a visualization comprising visual information describing information corresponding to the date-time interval of the natural language utterance; and
providing the visualization to a user device.

15. One or more non-transitory computer-readable media storing instructions which, when executed by one or more processors, cause a system to perform operations comprising:
providing an enhanced grammar, a natural language utterance comprising a date-time interval, and database schema information to a machine learning model that has been trained to convert natural language utterances to logical forms; and
using the machine learning model to convert the natural language utterance to an output logical form, wherein the output logical form comprises at least one of the date-time interval and an extraction function for extracting date-time information corresponding to the date-time interval from at least one date-time attribute of the database schema information.

16. The one or more non-transitory computer-readable media of claim 15, wherein the output logical form comprises the extraction function, wherein the enhanced grammar comprises a set of relational algebra operators and a set of date-time extraction functions, and wherein the machine learning model converts the natural language utterance to the output logical form based at least in-part on selecting the extracting function from the set of date-time extraction functions.

17. The one or more non-transitory computer-readable media of claim 16, the operations further comprising:
prior to using the machine learning model to convert the natural language utterance to the output logical form:
accessing a grammar comprising the set of relational algebra operators; and
generating the enhanced grammar by adding the set of date-time extraction functions to the grammar.

18. The one or more non-transitory computer-readable media of claim 15, wherein the machine learning model has been trained to convert natural language utterances to logical forms by:
accessing training data comprising a set of training examples;
generating a set of augmented training examples from training examples in the set of training examples by:
identifying a subset of training examples in the set of training examples that include date-time intervals;
associating the date-time intervals with first extraction functions included in a set of extraction functions that are configured to extract date-time information from date-time attributes included in a database schema;
selecting second extraction functions included in the set of extraction functions that are different from the first extraction functions; and
modifying logical forms and natural language utterances of training examples in the subset of training examples based on the second extraction functions to result in the set of augmented training examples;
generating augmented training data by combining the set of augmented training examples and the set of training examples; and
using the augmented training data to train the machine learning model to convert natural language utterances to logical forms.

19. The one or more non-transitory computer-readable media of claim 15, wherein the output logical form comprises the date-time interval, and the operations further comprising:
processing the output logical form to generate a processed output logical form, wherein the processing output logical form to generate the processed output logical form comprises identifying a portion of the output logical form that comprises a logical form operator and the date-time interval and replacing the portion with a replacement extraction function selected from a set of extraction functions that are configured to extract date-information from date-time attributes included in a database schema.

20. The one or more non-transitory computer-readable media of claim 19, the operations further comprising:
translating the processed output logical form to a query language output statement;
providing the query language output statement to a cloud-based platform;
using the cloud-based platform to execute the query language output statement on a database associated with the database schema information to retrieve a result describing information corresponding to the date-time interval of the natural language utterance or generate a visualization comprising visual information describing information corresponding to the date-time interval of the natural language utterance, or a combination thereof; and
providing the result or the visualization to a user device.
